(19) United States
(12) Patent Application Publication
(10) Pub. No.: US 2010/0274556 A1
(43) Pub. Date: Oct. 28, 2010

(54) VECTOR QUANTIZER, VECTOR INVERSE QUANTIZER, AND METHODS THEREFOR

(75) Inventors: Kaoru Sato, Kanagawa (JP); Toshiyuki Morii, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/810,049

(22) PCT Filed: Jan. 15, 2009
(86) PCT No.: PCT/JP2009/000132

§ 371 Date: Jun. 22, 2010

(30) Foreign Application Priority Data
Jan. 16, 2008 (JP) 2008-007417
May 30, 2008 (JP) 2008-143278
Dec. 12, 2008 (JP) 2008-317398

(51) Int. Cl. G10L 19/00

(52) U.S. Cl. 704/201; 704/E19.001

(57) ABSTRACT

Disclosed is a vector quantizer in which, in multistage vector quantization, the vector quantization of the following stage can be performed adaptively to the result of the vector quantization of the preceding stage to improve the accuracy of the quantization at less calculation amount and bit rate. The quantizer comprises a product set circle calculating section (108) for calculating a product set circle indicating a product set of a cluster circle of a first code vector selected as the result of the quantization of a first stage from a first codebook (101) and a cluster circle of a second code vector selected as the result of the quantization of a second stage from a second codebook (105), and an adjusting section (109) for adjusting an quantization error of the second stage or a third codebook so that a cluster circle of the third codebook indicating a set of all vectors represented by all vectors of the third codebook is consistent with the product set circle calculated by the product set circle calculating section (108).

### TECHNICAL FIELD

The present invention relates to a vector quantization apparatus, vector dequantization apparatus, and quantization and dequantization methods for performing vector quantization. In particular, the present invention relates to a vector quantization apparatus, vector dequantization apparatus and quantization and dequantization methods for performing vector quantization of LSP (Line Spectral Pair) parameters used in a speech coding and decoding apparatus that transmits speech signals in the fields of a packet communication system represented by Internet communication, a mobile communication system, and so on.

### BACKGROUND ART

In the field of digital wireless communication, packet communication represented by Internet communication and speech storage, speech signal coding and decoding techniques are essential for effective use of channel capacity and storage media for radio waves. In particular, a CELP (Code Excited Linear Prediction) speech coding and decoding technique is the mainstream technique.

A CELP speech coding apparatus encodes input speech based on pre-stored speech models. To be more specific, the CELP speech coding apparatus separates a digital speech signal into frames of regular time intervals (e.g., approximately 10 to 20 ms), performs a linear prediction analysis of the speech signal on a per frame basis, finds the linear prediction coefficients (“LPC's”) and linear prediction residual vector, and encodes the linear prediction coefficients and linear prediction residual vector separately. As a method of encoding linear prediction coefficients, generally, linear prediction coefficients are converted into LSP (Line Spectral Pair) parameters and these LSP parameters are encoded. Also, as a method of encoding LSP parameters, vector quantization is often performed for LSP parameters. Here, vector quantization refers to the method of selecting the most similar code vector to the quantization target vector from a codebook having a plurality of representative vectors (i.e. code vectors), and outputting the index (code) assigned to the selected code vector as a quantization result. In vector quantization, the codebook size is determined based on the amount of information that is available. For example, when vector quantization is performed using an amount of information of 8 bits, a codebook can be formed using 256 (=2⁸) types of code vectors.

Also, to reduce the amount of information and the amount of calculations in vector quantization, various techniques are used, including MSVQ (Multi-Stage Vector Quantization) and SVQ (Split Vector Quantization) disclosed in Non-Patent Document 1. Here, multi-stage vector quantization is a method of performing vector quantization of a vector once and further performing vector quantization of the quantization error, and split vector quantization is a method of quantizing a plurality of split vectors acquired by splitting a vector.

Non-Patent Document 1: Allen Gersho, Robert M. Gray, translated by Yoshii and three others, “Vector Quantization and Signal Compression,” Corona Publishing Co., Ltd, 10 Nov. 1998, pages 506 and 524 to 531

### DISCLOSURE OF INVENTION

### Problems to be Solved by the Invention

In multi-stage vector quantization, a target vector is represented by the combination of code vectors selected in individual stages. Therefore, if all combinations of code vectors in each stage provide independent representative clusters that do not overlap, the accuracy of quantization improves and the efficiency of quantization improves. Here, a cluster refers to a set of target vectors represented by a code vector. However, in the multi-stage vector quantization disclosed in Non-Patent Document 1, the clusters represented by all combinations of code vectors in each stage overlap partly. That is, there are two or more combinations of code vectors in each stage for representing part of clusters, and, consequently, the accuracy of quantization is degraded and the quantization bit rate is increased.

FIG. 1 illustrates problems with the multi-stage vector quantization disclosed in Non-Patent Document 1.

In FIG. 1A, the black circles each exemplify part of the first code vectors forming the first codebook used in the first-stage vector quantization. The two-dimensional spaces separated by solid lines show vector set areas (i.e. clusters) represented by the respective first code vectors. Also, in the following, vector sets represented respectively by all code vectors forming a codebook will be referred to as the cluster of this codebook. As shown in FIG. 1A, clusters represented by the respective first code vectors are independent and do not overlap.

Vector quantization means searching for the code vector representing the cluster to which the target vector of the quantization target belongs. First, the first-stage vector quantization is performed to select one first code vector. FIG. 1B shows a state where one first code vector is selected in the first-stage vector quantization. In FIG. 1B, crossed circle 11 shows the target vector, and the area surrounded by dashed lines shows the cluster to which the target vector belongs. Also, black circle 12 shows a first code vector representing the cluster to which the target vector belongs.

Next, second-stage vector quantization is performed to select one of the second code vectors forming a second codebook. FIG. 1C shows a state where second-stage vector quantization is performed to select one second code vector. Further, FIG. 1C shows the second code vector selected in second-stage vector quantization, further using white circle 13 based on FIG. 1B. Here, the area surrounded by dotted lines schematically shows the cluster represented by the second code vector selected in the second-stage vector quantization. As is not shown in the figure for ease of explanation, there are other second code vectors and clusters represented by these second code vectors around the selected second code vector. Also, in this case, the clusters represented by the respective second code vectors are independent and do not overlap. Second-stage vector quantization is performed based on the first code vector (i.e. black circle 12) selected in the first-stage vector quantization, thereby further making the second code vector of the quantization result (i.e. white circle 13) closer to the target vector (i.e. crossed circle 11).

As shown in FIG. 1, the first code vector of black circle 12 is selected in the first-stage vector quantization (see FIG. 1B), and the second code vector of white circle 13 is selected in second-stage vector quantization (see FIG. 1C). Here, as described above (see FIG. 1B and FIG. 1C), clusters represented by the respective first code vectors are independent and do not overlap, and clusters represented by the respective second code vectors are independent and do not overlap. Therefore, it is estimated that the target vector (i.e. crossed circle 11) is necessarily included in the set intersection of the cluster represented by black circle 12 and the cluster represented by white circle 13. However, according to the multi-stage vector quantization disclosed in Non-Patent Document 1, subsequent third-stage vector quantization is performed based on the second code vector selected in second-stage vector quantization (i.e. white circle 13), and other areas than the above set intersection are searched to select a third code vector. Therefore, the efficiency and accuracy of third-stage vector quantization degrade.

It is therefore an object of the present invention to provide a vector quantization apparatus, vector dequantization apparatus, and quantization and dequantization methods for improving the accuracy of quantization by performing subsequent-stage vector quantization based on earlier-stage vector quantization results in multi-stage vector quantization.

Means for Solving the Problem

The vector quantization apparatus of the present invention employs a configuration having: N codebooks from a first codebook to an N-th codebook (where N is an integer equal to or greater than 3) that each store a plurality of code vectors; (N−1) radius codebooks from a first radius codebook to an (N−1)-th radius codebook that store radiuses of cluster circles showing vector sets represented respectively by code vectors of the first codebook to the (N−1)-th codebook; a first calculating section that calculates a difference between each code vector of the first codebook and a quantization target vector, as a first residual vector; an m-th calculating section that calculates a difference between each code vector of an m-th (m=2, 3, . . . , N−1) codebook and an (m−1)-th residual vector associated with a code vector selected from an (m−1)-th codebook, as an m-th residual vector; a set intersection circle calculating section that calculates a set intersection circle showing a set intersection of a cluster circle of a code vector selected from an (N−2)-th codebook and a cluster circle of a code vector selected from the (N−1)-th codebook; an adjusting section that adjusts one of an (N−1)-th residual vector associated with the code vector selected from the (N−1)-th codebook and the N-th codebook, such that a cluster circle of the N-th codebook showing all vector sets represented by all vectors of the N-th codebook and the set intersection circle match each other; an N-th calculating section that calculates a difference between the (N−1)-th residual vector associated with the code vector selected from the (N−1)-th codebook and each code vector of the N-th codebook adjusted, or calculates a difference between the (N−1)-th residual vector adjusted and each code vector of the N-th codebook, as an N-th residual vector; and a selecting section that selects a code vector closest to the quantization target vector from the first codebook and selects a code vector closest to an (n−1)-th residual vector from an n-th (where n=2, 3, . . . , N) codebook.

The vector quantization apparatus of the present invention employs a configuration having: N codebooks from a first codebook to an N-th codebook (where N is an integer equal to or greater than 3) that each store a plurality of code vectors; a first calculating section that calculates a difference between each code vector of the first codebook and a quantization target vector, as a first residual vector; an m-th calculating section that calculates a difference between each code vector of an m-th (m=2, 3, . . . , N−1) codebook and an (m−1)-th residual vector associated with a code vector selected from an (m−1)-th codebook, as an m-th residual vector; a quantization section that acquires an (m−1)-th code by performing vector quantization of one of an input vector and the (m−1)-th residual vector using the (m−1)-th codebook, and acquires an m-th code by performing vector quantization of the m-th residual vector; a set intersection circle calculating section that selects and outputs a radius and center of a set intersection circle showing a set intersection of a cluster circle of a code vector selected from an (N−2)-th codebook and a cluster circle of a code vector selected from an (N−1)-th codebook, based on an (N−2)-th code and (N−1)-th code; an adjusting section that adjusts one of an (N−1)-th residual vector associated with the code vector selected from the (N−1)-th codebook and the N-th codebook, such that a cluster circle of the N-th codebook showing all vector sets represented by all vectors of the N-th codebook and the set intersection circle match each other; an N-th calculating section that calculates a difference between the (N−1)-th residual vector associated with the code vector selected from the (N−1)-th codebook and each code vector of the N-th codebook adjusted, or calculates a difference between the (N−1)-th residual vector adjusted and each code vector of the N-th codebook, as an N-th residual vector; and a selecting section that selects a code vector closest to the quantization target vector from the first codebook and selects a code vector closest to an (n−1)-th residual vector from an n-th (where n=2, 3, . . . , N) codebook.

The vector quantization apparatus of the present invention employs a configuration having: N codebooks from a first codebook to an N-th codebook (where N is an integer equal to or greater than 3) that each store a plurality of code vectors; (N−1) radius codebooks from a first radius codebook to an (N−1)-th radius codebook that store radiuses of cluster circles showing vector sets represented respectively by code vectors of the first codebook to the (N−1)-th codebook; a first calculating section that calculates a difference between each code vector of the first codebook and a quantization target vector, as a first residual vector; an m-th calculating section that calculates a difference between each code vector of an m-th (m=2, 3, . . . , N−1) codebook and an (m−1)-th residual vector associated with a code vector selected from an (m−1)-th codebook, as an m-th residual vector; a set intersection circle calculating section that calculates a set intersection circle showing a set intersection of a cluster circle of a code vector selected from an (N−2)-th codebook and a cluster circle of a code vector selected from the (N−1)-th codebook; an adjusting section that adjusts one of an (N−1)-th residual vector associated with the code vector selected from the (N−1)-th codebook and the N-th codebook, such that a cluster circle of the N-th codebook showing all vector sets represented by all vectors of the N-th codebook and the set intersection circle match each other; an N-th calculating section that calculates a difference between the (N−1)-th residual vector associated with the code vector selected from the (N−1)-th codebook and each code vector of the N-th codebook adjusted, or calculates a difference between the (N−1)-th residual vector adjusted and each code vector of the N-th codebook, as an N-th residual vector; and a selecting section that selects a code vector closest to the quantization target vector from the first codebook, selects a code vector closest to an (n−1)-th residual vector from an n-th (where n=2, 3, . . . , N) codebook, and, among a plurality of code vectors extracted from the (N−1)-th codebook in order from a code vector closest to an (N−2)-th residual vector, selects a code vector to minimize a radius of the set intersection circle showing the set intersection with the cluster circle of the code vector selected from the (N−2)-th codebook.

The vector dequantization apparatus of the present invention employs a configuration having: a receiving section that receives an n-th code (n=1, 2, . . . , N, where N is an integer equal to or greater than 3) acquired by performing quantization in an n-th stage for an input vector in a vector quantization apparatus; N codebooks from a first codebook to an N-th codebook that each store a plurality of code vectors; (N−1) radius codebooks from a first radius codebook to an (N−1)-th radius codebook that store radiuses of cluster circles showing vector sets represented respectively by code vectors of the first codebook to the (N−1)-th codebook; a first adding section that acquires a first addition vector by adding a code vector indicated by a first code in the first codebook and a code vector indicated by a second code in a second codebook; an m-th adding section that acquires an m-th addition vector by adding a code vector indicated by an m-th (m=2, 3, . . . , N−1) code in an m-th codebook and an (m−1)-th addition vector; a set intersection circle calculating section that calculates a set intersection circle showing a set intersection of a cluster circle of a code vector indicated by an (N−2)-th code in an (N−2)-th codebook and a cluster circle of a code vector indicated by an (N−1)-th code in the (N−1)-th codebook; an adjusting section that adjusts one of an (N−1)-th addition vector and an N-th code vector, such that a cluster circle of the N-th code vector, which is a code vector indicated by an N-th code in the N-th codebook, and the set intersection circle match each other; and an N-th adding section that acquires a quantized vector by adding the N-th code vector adjusted and the (N−1)-th addition vector or by adding the (N−1)-th addition vector adjusted and the N-th code vector.

The vector quantization method of the present invention includes: N codebooks from a first codebook to an N-th codebook (where N is an integer equal to or greater than 3) that each store a plurality of code vectors; (N−1) radius codebooks from a first radius codebook to an (N−1)-th radius codebook that store radiuses of cluster circles showing vector sets represented respectively by code vectors of the first codebook to the (N−1)-th codebook; a first calculating step of calculating a difference between each code vector of the first codebook and a quantization target vector, as a first residual vector; an m-th calculating step of calculating a difference between each code vector of an m-th (m=2, 3, . . . , N−1) codebook and an (m−1)-th residual vector associated with a code vector selected from an (m−1)-th codebook, as an m-th residual vector; a set intersection circle calculating step of calculating a set intersection circle showing a set intersection of a cluster circle of a code vector selected from an (N−2)-th codebook and a cluster circle of a code vector selected from the (N−1)-th codebook; an adjusting step of adjusting one of an (N−1)-th residual vector associated with the code vector selected from the (N−1)-th codebook and the N-th codebook, such that a cluster circle of the N-th codebook showing all vector sets represented by all vectors of the N-th codebook and the set intersection circle match each other; an N-th calculating step of calculating a difference between the (N−1)-th residual vector associated with the code vector selected from the (N−1)-th codebook and each code vector of the N-th codebook adjusted, or calculating a difference between the (N−1)-th residual vector adjusted and each code vector of the N-th codebook, as an N-th residual vector; and a selecting step of selecting a code vector closest to the quantization target vector from the first codebook and selecting a code vector closest to an (n-1)-th residual vector from an n-th (where n=2, 3, . . . , N) codebook.

### ADVANTAGEOUS EFFECT OF THE INVENTION

According to the present invention, upon performing multi-stage quantization for vectors such as LSP parameters, the vector space of a code vector used in subsequent-stage quantization is adequately adjusted based on the quantization results of two earlier stages, so that it is possible to improve the accuracy of quantization.

### BRIEF DESCRIPTION OF DRAWINGS

FIG. 1 illustrates problems with multi-stage vector quantization according to the prior art;

FIG. 2 illustrates the principle of the present invention;

FIG. 3 specifically illustrates the principle of the present invention shown in FIG. 2;

FIG. 4 specifically illustrates the principle of the present invention shown in FIG. 2;

FIG. 5 is a block diagram showing the main components of a vector quantization apparatus according to Embodiment 1 of the present invention;

FIG. 6 is a block diagram showing the configuration inside a set intersection circle calculating section according to Embodiment 1 of the present invention;

FIG. 7 is a block diagram showing the main components of a vector dequantization apparatus according to Embodiment 1 of the present invention;

FIG. 8 is a block diagram showing the main components of a vector quantization apparatus according to Embodiment 2 of the present invention;

FIG. 9 is a block diagram showing the configuration of a set intersection circle calculating section according to Embodiment 2 of the present invention; and

FIG. 10 is a block diagram showing the main components of a vector quantization apparatus according to Embodiment 3 of the present invention.

### BEST MODE FOR CARRYING OUT THE INVENTION

Embodiments of the present invention will be explained below in detail with reference to the accompanying drawings.

### Embodiment 1

First, the principle of the present invention will be explained.

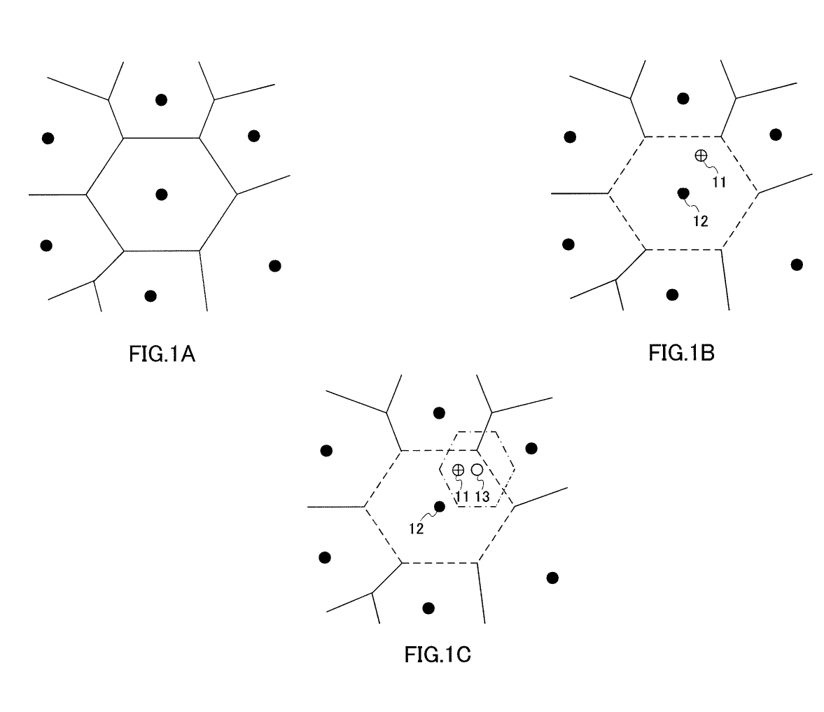

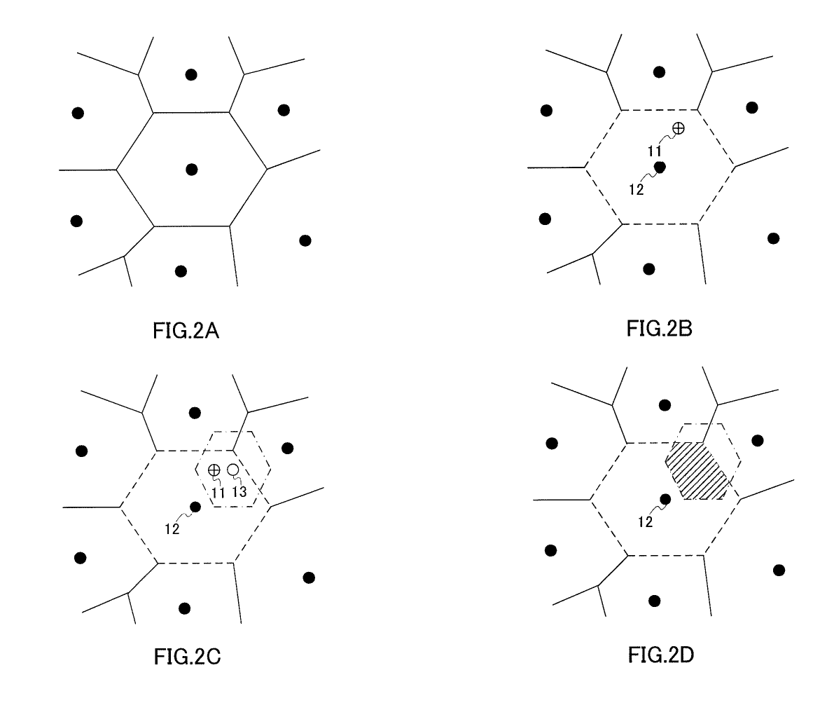

FIG. 2 illustrates the principle of the present invention. Also, FIG. 2 is basically the same as FIG. 1, and differs from FIG. 1 only in adding FIG. 2D. That is, FIGS. 2A to 2C are the same as FIGS. 1A to 1C, and therefore their explanation will be omitted.

FIG. 2D shows the set intersection of the cluster represented by a first code vector (i.e. black circle 12) selected in the first-stage vector quantization and the cluster represented by a second code vector (i.e. the white circle) selected in second-stage vector quantization, using a hatch area. As described above (see FIG. 1B and FIG. 1C), clusters represented by the respective first code vectors are independent and do not overlap, and clusters represented by the respective second code vectors are independent and do not overlap. Therefore, it is estimated that the target vector (i.e. crossed circle 11) is necessarily included in the set intersection of the cluster represented by black circle 12 and the cluster represented by white circle 13. With the present invention, code vector search in vector quantization after second stage (e.g. third-stage vector quantization) is limited to the above set intersection area, and therefore an adaptive control is performed such that the average and distribution of clusters, which are represented by all code vectors (e.g. third code vectors) forming a codebook (e.g. a third codebook) used in vector quantization after the second stage (e.g. third-stage vector quantization), stay within the set intersection (i.e. the hatch area). By this means, it is possible to maintain cluster groups represented by combinations of all code vectors independently, and, in vector quantization after the second stage (e.g. third-stage vector quantization), limit the search range for a third code vector to the set intersection. Therefore, the efficiency and accuracy of vector quantization after the second stage improves.

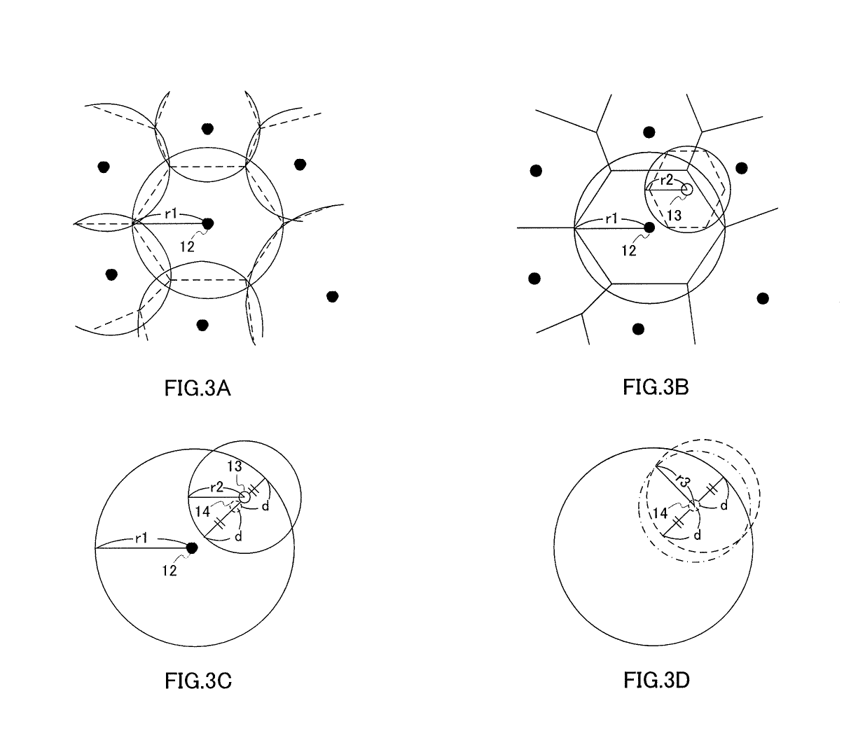

FIG. 3 specifically illustrates the principle of the present invention shown in FIG. 2.

In FIG. 3A, the black circles exemplify part of the first code vectors forming the first codebook used in the first-stage vector quantization. The two-dimensional areas separated by dashed lines indicate the clusters of the first code vectors, and these first code vector clusters are approximated by circles. The circle approximating each cluster (hereinafter “cluster circle”) has a first code vector as the center of the circle. Also, upon first codebook learning, the radius of each cluster circle equals the distance between a first code vector and the learning vector farthest from the first code vector among the learning vectors belonging to each first code vector cluster. Also, it is equally possible to extend the radius of a cluster circle determined in the above method by multiplying the radius by a constant such that the cluster circle contains more target vectors. Here, the radius of the cluster circle of each code vector is determined in advance upon learning of all codebooks, and stored in a cluster radius codebook. As an example of deciding a cluster circle,

FIG. 3A shows the radius of the cluster circle represented by the first code vector of black circle 12 using r1.

FIG. 3B exemplifies a position relationship between the cluster circle of the first code vector selected in the first-stage vector quantization and the cluster circle of a second code vector selected in second-stage vector quantization. The vector quantization apparatus according to the present invention selects a code vector by performing vector quantization in each stage, and selects the radius of the cluster circle of the code vector selected in each stage, from a cluster radius codebook. In FIG. 3B, r1 indicates the radius of the cluster circle of the first code vector (i.e. black circle 12), and r2 indicates the radius of the cluster circle of the second code vector (i.e. white circle 13). By this means, a position relationship between clusters of code vectors selected in individual stages of vector quantization is approximated by cluster circles. In the following, the cluster circle of the first code vector (i.e. black circle 12) will be referred to as “cluster circle r1,” and the cluster circle of the second code vector (white circle 13) will be referred to as “cluster circle r2.”

Next, the set intersection of cluster circle r1 and cluster circle r2 is approximated by a circle. In the following, a circle indicating the set intersection of cluster circle r1 and cluster circle r2 will be equally referred to as “set intersection circle.” FIG. 3C shows the middle point of the set intersection circle of cluster circle r1 and cluster circle r2. To be more specific, using dashed-line circle 14, FIG. 3C shows the center of a set intersection circle approximating the set intersection of cluster circle r1 and cluster circle r2. The center of the set intersection circle (i.e. dashed-line circle 14) is located on the straight line passing through the center of cluster circle r1 and the center of cluster circle r2. The distance from dashed-line circle 14 to the set intersection of cluster circle r1 and cluster circle r2 is d on both sides of the straight line. That is, these two distances are d.

FIG. 3D shows the set intersection circle of cluster circle r1 and cluster circle r2. In FIG. 3D, for ease of illustration, cluster circle r1 is shown by a solid line circle, and cluster circle r2 is shown by a dashed-line circle. Here, the radius and center of these cluster circles are not shown in the figure. In FIG. 3D, distance d is the same as distance d in FIG. 3C, and r3 indicates the radius of the set intersection circle. Also, the set intersection circle is shown by a dotted-line circle. The center and radius of the set intersection circle can be determined by the distance between the first code vector and the second code vector and by radiuses r1 and r2 of the cluster circles. Also, in vector quantization according to the present invention, after the cluster circle of a third codebook is adjusted to match set intersection circle r3, third-stage vector quantization is performed.

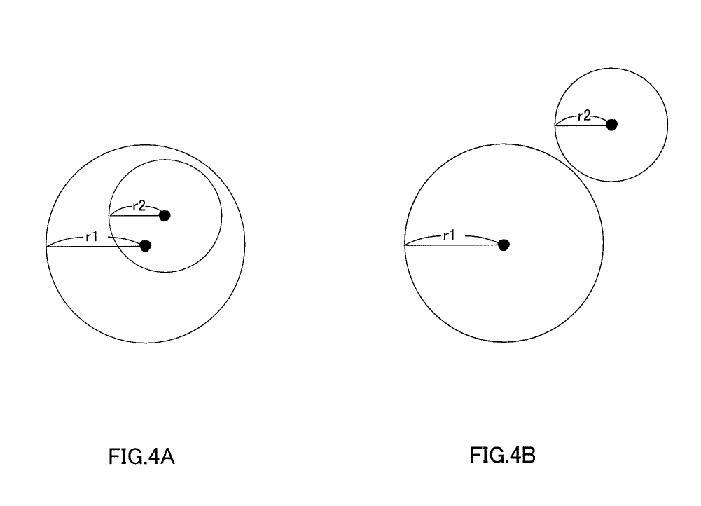

Also, as shown in FIG. 4A, when cluster circle r2 is completely included in cluster circle r1, cluster circle r2 is used as is as set intersection circle r3. That is, r3 equals r2. Also, as shown in FIG. 4B, even when there is no set intersection of cluster circle r1 and cluster circle r2, cluster circle r2 is used as is as set intersection circle r3.

In vector quantization according to the present invention, upon performing third-stage vector quantization, the entire of a third codebook is added or multiplied by coefficients such that the cluster of the third codebook stays within that set intersection circle r3. By this means, the efficiency and accuracy of vector quantization after a second stage improves. In the following, with embodiments of the present invention, the method of determining the center and radius of this set intersection circle r3 will be explained.

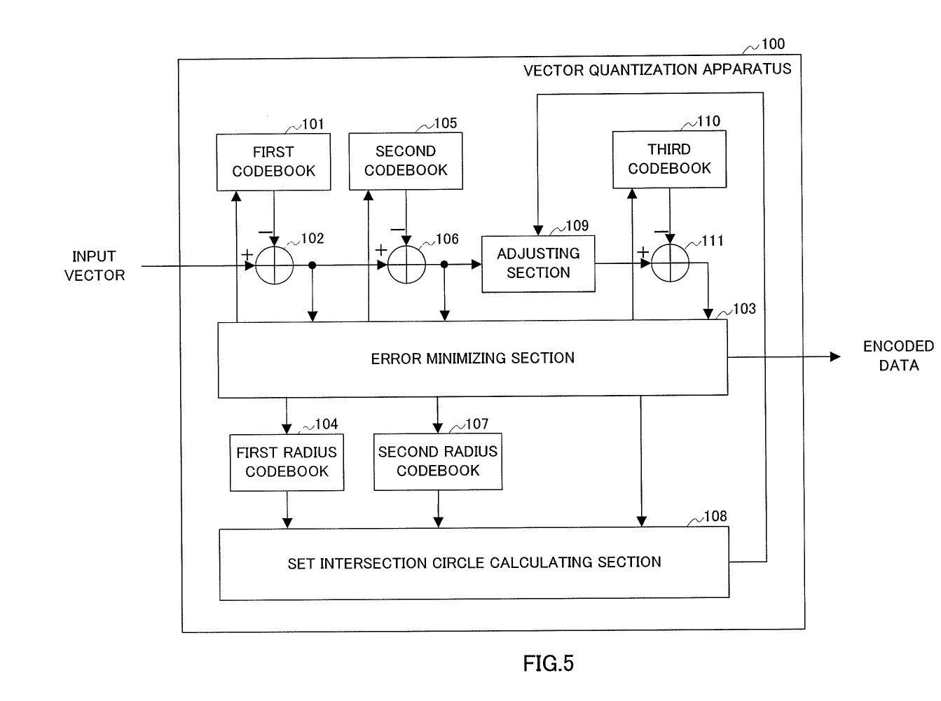

FIG. 5 is a block diagram showing the main components of vector quantization apparatus 100 according to Embodiment 1 of the present invention. The quantization target of vector quantization apparatus 100 is, for example, LSP vectors or other vectors. Also, an example case will be explained below where an input vector of the quantization target of vector quantization apparatus 100 is subjected to vector quantization by multi-stage vector quantization of three steps.

Vector quantization apparatus 100 is provided with first codebook 101, adder 102, error minimizing section 103, first radius codebook 104, second codebook 105, adder 106, second radius codebook 107, set intersection circle calculating section 108, adjusting section 109, third codebook 110 and adder 111.

First codebook 101 selects a first code vector designated by error minimizing section 103, from the built-in codebook, and outputs the first code vector to adder 102.

Adder 102 calculates the difference between an input vector received from outside as the vector quantization target and the first code vector received as input from first codebook 101, and outputs a vector of this difference to error minimizing section 103 and adder 106 as the first residual vector.

Error minimizing section 103 calculates the square errors between the input vector and first code vectors, using the first residual vector received as input from adder 102, and selects the first code vector to minimize the square error from first codebook 101. Next, error minimizing section 103 calculates the square errors between the first residual vector and second code vectors, using a second residual vector received as input from adder 106, and selects the second code vector to minimize the square error from second codebook 105. Further, error minimizing section 103 calculates the square errors between the second residual vector and third code vectors, using a third residual vector received as input from adder 111, and selects the third code vector to minimize the square error from third codebook 110. Processing of selecting these code vectors is sequentially performed so that a code vector is selected from one codebook before a code vector is selected from the next codebook. Further, error minimizing section 103 outputs the index of the first code vector to first radius codebook 104, outputs the index of the second code vector to second radius codebook 107 and outputs the second code vector to set intersection circle calculating section 108, every time these code vectors are selected. Next, error minimizing section 103 collectively encodes the indices assigned to the three selected code vectors and outputs the resulting encoded data.

First radius codebook 104 receives as input the index of the first code vector from error minimizing section 103, selects the first radius associated with this index from the built-in codebook and outputs the first radius to set intersection circle calculating section 108. Here, the first radius refers to the radius of the cluster circle of the first code vector. The first radius is calculated at the time first codebook 101 is prepared in advance by learning algorithms.

Second codebook 105 selects a second code vector designated by error minimizing section 103 from the built-in codebook and outputs this second code vector to adder 106.

Adder 106 calculates the difference between the first residual vector received as input from adder 102 and the second code vector received as input from second codebook 105, and outputs a vector of this difference to error minimizing section 103 and adjusting section 109 as a second residual vector.

Second radius codebook 107 receives as input the index of the second code vector from error minimizing section 103, selects the second radius associated with this index from the built-in codebook and outputs the second radius to set intersection circle calculating section 108. Here, the second radius refers to the radius of the cluster circle of the second code vector. The second radius is calculated at the time second codebook 105 is prepared in advance by learning algorithms.

Set intersection circle calculating section 108 calculates the center and radius of a set intersection circle using the first radius received as input from first radius codebook 104, the second radius received as input from second radius codebook 107 and the second code vector received as input from error minimizing section 103, and outputs the results to adjusting section 109. Also, set intersection circle calculating section 108 will be described later in detail.

Adjusting section 109 receives as input the second residual vector from adder 106, adjusts this second residual vector using the center and radius of the set intersection circle received as input from set intersection circle calculating section 108, and outputs the adjusted second residual vector to adder 111. In third-stage vector quantization, the result of adjusting the second residual vector based on the center and radius of the set intersection circle and performing vector quantization, is the same as the result of adjusting third codebook 110 in a reverse manner based on the center and radius of that set intersection circle and performing vector quantization. Therefore, by adjustment processing of moving the second residual vector and changing the size of this second residual vector based on the center and radius of the set intersection circle, adjusting section 109 provides the same effect as adjustment processing of moving the center and changing the radius for third codebook 110.

Third codebook 110 selects a third code vector designated by error minimizing section 103 from the built-in codebook, and outputs the third code vector to adder 111.

Adder 111 calculates the difference between the adjusted second residual vector received as input from adjusting section 109 and the third code vector received as input from third codebook 110, and outputs a vector of this difference to error minimizing section 103 as a third residual vector.

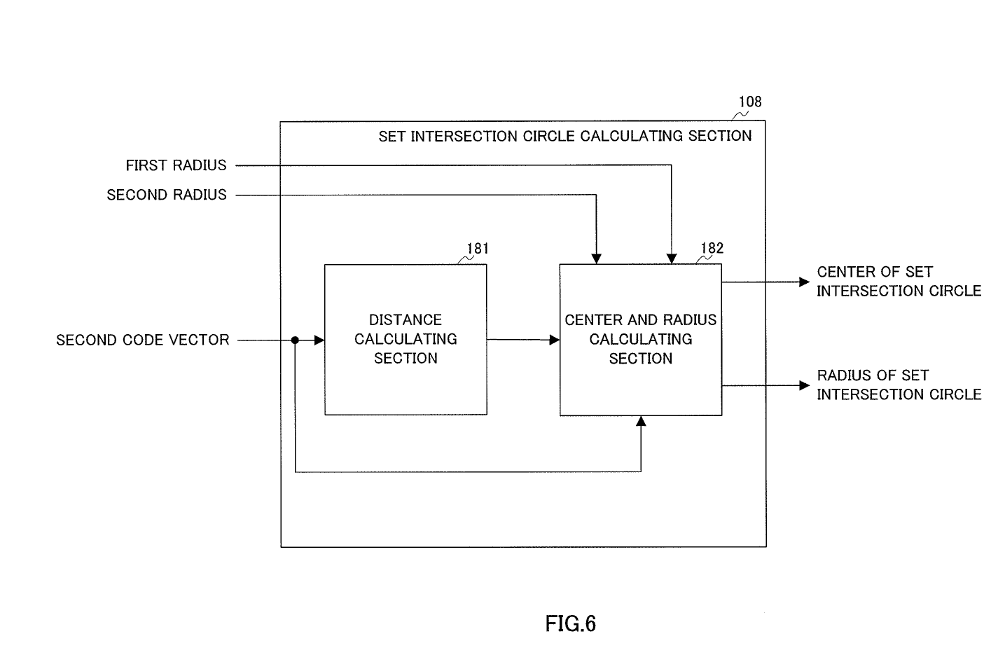

FIG. 6 is a block diagram showing the configuration inside set intersection circle calculating section 108.

In FIG. 6, using a second code vector received as input from error minimizing section 103, distance calculating section 181 calculates distance d, which is a parameter for calculating the center and radius of a set intersection circle, and outputs distance d to center and radius calculating section 182.

Center and radius calculating section 182 calculates the center and radius of the set intersection circle using a first radius received as input from first radius codebook 104, second radius received as input from second radius codebook 107, second code vector received as input from error minimizing section 103 and distance d received as input from distance calculating section 181, and outputs the results to adjusting section 109.

The operations of the components of vector quantization apparatus 100 will be explained. Also, an example case will be explained where the order of an input vector of the quantization target is R, and this input vector will be expressed as “V(i)” (i=0, 1, . . . , R−1).

First codebook 101 selects first code vector CODE_{—}1^{(d1′)}(i) (i=0, 1, . . . , R−1) from first code vectors CODE_{—}1^{(d1)}(i) (d1=0, 1, . . . , D1−1, i=0, 1, . . . , R−1) forming the built-in codebook, by designation d1′ from error minimizing section 103, and outputs the result to adder 102. Here, D1 is the total number of code vectors of first codebook 101, and d1 is the code vector index. Error minimizing section 103 designates an output code vector to first codebook 101 by sequentially changing the value of d1′ from d1′=0 to d1′=D1−1.

Adder 102 calculates the difference between input vector V(i) (i=0, 1, . . . , R−1) of the quantization target and first code vector CODE_{—}1^{(d1′)}(i) (i=0, 1, . . . , R−1) received as input from first codebook 101, according to following equation 1, and, as the first residual vector, outputs a vector of this difference, Err_{—}1^{(d1′)}(i) (i=0, 1, . . . , R−1), to error minimizing section 103 and adder 106.

(Equation 1)

Err_{—}1^{(d1′)}(i)=V(i)−CODE_{—1}^{(d1′)}(i) (i=0, 1, . . . , R−1) [1]

Error minimizing section 103 designates code vector index d1′ to first codebook 101 and calculates square error Err according to following equation 2, using first residual vector Err_{—}1^{d1′)}(i) (i=0, 1, . . . , R−1) received as input from adder 102 every designation.

$$\begin{matrix}( Equation 2 ) & \\ Err = {\sum }_{i = 0}^{R - 1} {( Err\_ {1}^{( d {1}^{′} )} ( i ) )}^{2} & [ 2 ]\end{matrix}$$

Next, error minimizing section 103 stores index d1′ of the first code vector to minimize square error Err, as first index d1_min, and outputs first index d1_min to first radius codebook 104.

First radius codebook 104 outputs first radius r_{—}1^{(d1}^{_{—}}^{min)} associated with first index d1_min received as input from error minimizing section 103, to set intersection circle calculating section 108, among first radiuses r_{—}1^{d1)} (d1=0, 1, . . . , D1−1) forming the built-in codebook.

Second codebook 105 selects second code vector CODE_{—}2^{(d2′)} (i) (i=0, 1, . . . , R−1) from second code vectors CODE_{—}2^{(d2)}(i) (d2=0, 1, . . . , D2−1, i=0, 1, . . . , R−1) forming the built-in codebook, by designation d2′ from error minimizing section 103, and outputs the second code vector to adder 106. Here, D2 is the total number of code vectors of second codebook 105, and d2 is the code vector index. Error minimizing section 103 designates an output code vector to second codebook 105 by sequentially changing the value of d2′ from d2′=0 to d2′=D2−1.

Adder 106 calculates the difference between first residual vector Err_{—}1^{(d1}^{_{—}}^{min)}(i) (i=0, 1, . . . , R−1) received as input from adder 102 and second code vector CODE_{—}2^{(d2′)}(i) (i=0, 1, . . . , R−1) received as input from second codebook 105, according to following equation 3, and, as a second residual vector, outputs a vector of this difference, Err_{—}2^{(d2′)}(i) (i=0, 1, . . . , R−1), to error minimizing section 103 and adjusting section 109.

(Equation 3)

Err_{—}2^{(d2′)}(i)=Err_{—}1^{(d1}^{_{—}}^{min)}(i)−CODE_{—}2^{(d2′)}(i)=(i=0, 1, . . . , R−1) [3]

Error minimizing section 103 designates code vector index d2′ to second codebook 105 and calculates square error Err according to following equation 4, using second residual vector Err_{—}2^{(d2′)}(i) (i=0, 1, . . . , R−1) received as input from adder 106 every designation.

$$\begin{matrix}( Equation 4 ) & \\ Err = {\sum }_{i = 0}^{R - 1} {( Err\_ {2}^{( d {2}^{′} )} ( i ) )}^{2} & [ 4 ]\end{matrix}$$

Next, error minimizing section 103 stores index d2′ of the second code vector to minimize square error Err, as second index d2_min, and outputs second index d2_min to second radius codebook 107. Further, error minimizing section 103 outputs second code vector CODE_{—}2^{(d2}^{_{—}}^{min)}(i) (i=0, 1, . . . , R−1) to minimize square error Err, to set intersection circle calculating section 108.

Second radius codebook 107 outputs second radius r_{—}2^{(d2}^{_{—}}^{min)} associated with second index d2_min received as input from error minimizing section 103, to set intersection circle calculating section 108, among second radiuses r_{—}2^{(d2)} (d2=0, 1, . . . , D2−1) forming the built-in codebook.

In set intersection circle calculating section 108, using second code vector CODE_{—}2^{(d2}^{_{—}}^{min)}(i) (i=0, 1, . . . , R−1) received as input from error minimizing section 103, distance calculating section 181 calculates distance d between the first code vector and the second code vector according to following equation 5, and outputs distance d to center and radius calculating section 182. Although the first code vector is not used upon calculating distance d in equation 5, this is because the origin of the second code vector corresponds to the first code vector. Therefore, the length of the second code vector itself corresponds to the distance between those code vectors.

$$\begin{matrix}( Equation 5 ) & \\ d = \sqrt{{\sum }_{i = 0}^{R - 1} {( CODE\_ {2}^{( d 2 \_ min )} ( i ) )}^{2}} & [ 5 ]\end{matrix}$$

Next, according to following equations 6 and 7, center and radius calculating section 182 of set intersection circle calculating section 108 finds an approximate center and radius of the set intersection circle of the first code vector cluster circle and second code vector cluster circle, using first radius r_{—}1^{(d1}^{_{—}}^{min)} received as input from first radius codebook 104, second radius r_{—}2^{(d2}^{_{—}}^{min)} received as input from second radius codebook 107, second code vector CODE_{—}2^{(d2}^{_{—}}^{min)}(i) (i=0, 1, . . . , R−1) received as input from error minimizing section 103 and distance d received as input from distance calculating section 181.

$$\begin{matrix}( Equation 6 ) & \\ CENT ( i ) = 0 ( i = 0 , 1 , … , R - 1 ) \\ cent\_r = r\_ {2}^{( d 2 \_ min )} \\ if ( \begin{matrix}( r\_ {1}^{( d 1 \_ min )} - r\_ {2}^{( d 2 \_ min )} \geq d ) or \\ ( r\_ {1}^{( d 1 \_ min )} + r\_ {2}^{( d 2 \_ min )} \leq d )\end{matrix} ) & [ 6 ] \\ ( Equation 7 ) & \\ CENT ( i ) = \frac{\begin{matrix}r\_ {1}^{( d 1 \_ min )} - \\ r\_ {2}^{( d 2 \_ min )} - \\ d\end{matrix}}{2 d} \times CODE\_ {2}^{( d 2 \_ min )} ( i ) ( i = 0 , 1 , … , R - 1 ) \\ cent\_r = \sqrt{{( r\_ {2}^{( d 2 \_ min )} )}^{2} - {\sum }_{i = 0}^{R - 1} {( CENT ( i ) )}^{2}} \\ if ( \begin{matrix}( r\_ {1}^{( d 1 \_ min )} - r\_ {2}^{( d 2 \_ min )} < d ) and \\ ( r\_ {1}^{( d 1 \_ min )} + r\_ {2}^{( d 2 \_ min )} > d )\end{matrix} ) & [ 7 ]\end{matrix}$$

In equations 6 and 7, CENT(i) (i=0, 1, . . . , R−1) is the vector which indicates the center of the set intersection circle and which starts at second code vector CODE _{—}2^{(d2}^{_{—}}^{min)}(i) (i=0, 1, . . . , R−1) and ends at the center of the set intersection circle. Also, cent_r is the radius of the set intersection circle. Here, if there is no set intersection of the first code vector cluster circle and second code vector cluster circle, or if one cluster circle completely includes the other cluster circle, according to equation 6, set intersection circle center CENT(i) (i=0, 1, . . . , R−1) is set as a zero vector, and set intersection circle radius cent_r is set as second radius r_{—}2^{(d2}^{_{—}}^{min)}. That is, the second code vector cluster circle is used as is as a set intersection circle. Also, if there is a set intersection of the first code vector cluster circle and second code vector cluster circle, and one cluster circle does not completely include the other cluster circle, set intersection circle center CENT(i) (i=0, 1, . . . , R−1) and set intersection circle radius cent_r are calculated according to equation 7.

Next, set intersection circle calculating section 108 outputs set intersection circle center CENT(i) (i=0, 1, . . . , R−1) and set intersection circle radius cent_r to adjusting section 109.

Adjusting section 109 adjusts second residual vector Err_{—}2^{(d2}^{_{—}}^{min)}(i) (i=0, 1, . . . , R−1) received as input from adder 106 according to following equation 8, using set intersection circle center CENT(i) (i=0, 1, . . . , R−1) and set intersection circle radius cent_r received as input from set intersection circle calculating section 108.

$$\begin{matrix}( Equation 8 ) & \\ AD\_Err \_ 2 ( i ) = \frac{CBR\_ 3}{cent\_r} \times ( \begin{matrix}Err\_ {2}^{( d 2 \_ min )} ( i ) - \\ CENT ( i )\end{matrix} ) ( i = 0 , 1 , … , R - 1 ) & [ 8 ]\end{matrix}$$

In equation 8, CBR_{—}3 is the value showing the expanse of third codebook 110, and equals the distance from the zero point to the third code vector farthest from the zero point among third code vectors of third codebook 110. This value is determined at the time third codebook 110 is prepared in advance by learning algorithms. Also, the second residual vector after adjustment, AD_Err_{—}2(i) (i=0, 1, . . . , R−1), will be expressed as “adjusted second residual vector” below. By adjusting second residual vector Err_{—}2^{(d2}^{_{—}}^{min)}(i) (i=0, 1, . . . , R−1) of the third-stage vector quantization target using equation 8, it is possible to make the average and distribution of third codebook 110 adaptive to the set intersection circle. That is, adjusting section 109 adjusts second residual vector Err_{—}2^{(d2}^{_{—}}^{min)}(i) (i=0, 1, . . . , R−1) such that the cluster of third codebook 110 is included in the set intersection circle.

Next, adjusting section 109 outputs adjusted second residual vector AD_Err_{—}2(i) (i=0, 1, . . . , R−1) to adder 111.

Third codebook 110 selects third code vector CODE_{—}3(d3′)(i) (i=0, 1, . . . , R−1) from third code vectors CODE_{—}3^{(d3)}(i) (d3=0, 1, . . . , D3−1, i=0, 1, . . . , R−1) forming the built-in codebook, by designation d3′ from error minimizing section 103, and outputs the third code vector to adder 111. Here, D3 is the total number of code vectors of third codebook 110, and d3 is the code vector index. Error minimizing section 103 commands an output code vector to third codebook 110 by sequentially changing the value of d3′ from d3′=0 to d3′=D3−1.

Adder 111 calculates the difference between adjusted second residual vector AD_Err_{—}2(i) (i=0, 1, . . . , R−1) received as input from adjusting section 109 and third code vector CODE_{—}3^{(d3′)}(i) (i=0, 1, . . . , R−1) received as input from third codebook 110, according to following equation 9, and, as a third residual vector, outputs a vector of this difference, Err_{—}3^{(d3′)}(i) (i=0, 1, . . . , R−1), to error minimizing section 103.

(Equation 9)

Err_{—}3^{(d3′)}(i)=AD_Err_{—}2(i)−CODE_{—}3^{(d3′)}(i)=(i=0, 1, . . . , R−1) [9]

Error minimizing section 103 designates code vector index d3′ to third codebook 110 and calculates square error Err according to following equation 10, using third residual vector Err_{—}3^{(d3′)}(i) (i=0, 1, . . . , R−1) received as input from adder 110 every designation.

$$\begin{matrix}( Equation 10 ) & \\ Err = {\sum }_{i = 0}^{R - 1} {( Err\_ {3}^{( d {3}^{′} )} ( i ) )}^{2} & [ 10 ]\end{matrix}$$

Next, error minimizing section 103 stores index d3′ of the third code vector to minimize square error Err, as third index d₃_min.

Next, error minimizing section 103 collectively encodes first index d1_min, second index d2_min and third index d3_min, and outputs the resulting encoded data.

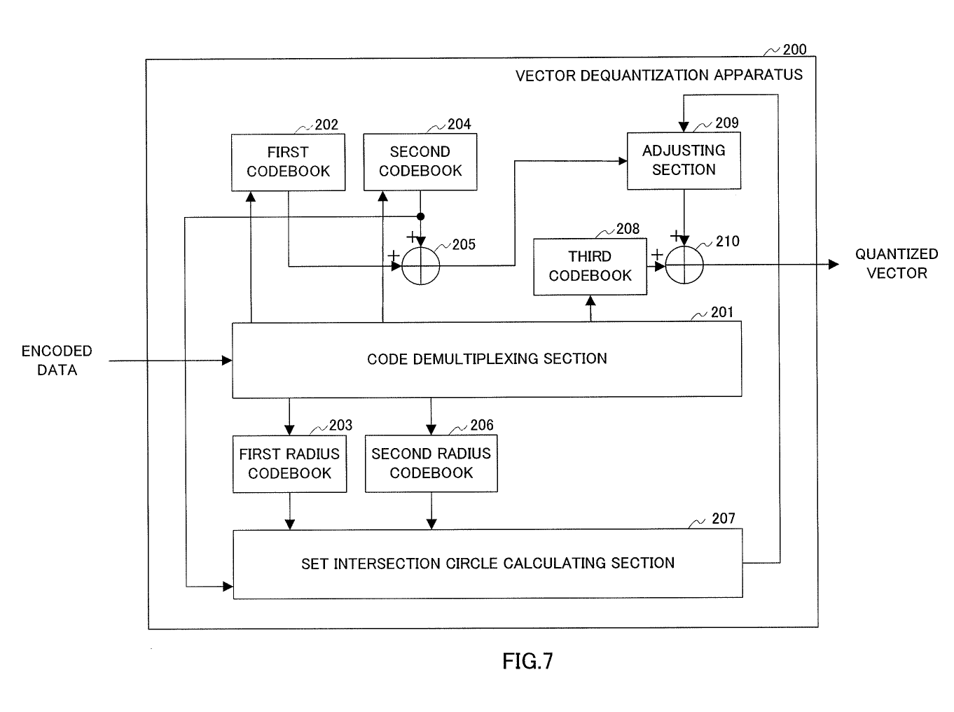

FIG. 7 is a block diagram showing the main components of vector dequantization apparatus 200 according to Embodiment 1 of the present invention. Vector dequantization apparatus 200 generates a quantized vector by decoding encoded data outputted in vector quantization apparatus 100.

In FIG. 7, vector dequantization apparatus 200 is provided with code demultiplexing section 201, first codebook 202, first radius codebook 203, second codebook 204, adder 205, second radius codebook 206, set intersection circle calculating section 207, third codebook 208, adjusting section 209 and adder 210. Here, first codebook 202 has the same codebook as the codebook provided in first codebook 101, first radius codebook 203 has the same codebook as the codebook provided in first radius codebook 104, second codebook 204 has the same codebook as the codebook provided in second codebook 105, second radius codebook 206 has the same codebook as the codebook provided in second radius codebook 107, and third codebook 208 has the same codebook as the codebook provided in third codebook 110.

Code demultiplexing section 201 receives as input encoded data and finds the first to third indices. Next, code demultiplexing section 201 commands first codebook 202 to output a code vector corresponding to the first index. Further, code demultiplexing section 201 outputs the first index to first radius codebook 203. Next, code demultiplexing section 201 commands second codebook 204 to output a code vector corresponding to the second index. Further, code demultiplexing section 201 outputs the second index to second radius codebook 206. Next, code demultiplexing section 201 commands third codebook 208 to output a code vector corresponding to the third index.

First codebook 202 outputs the code vector designated by code demultiplexing section 201 to adder 205 as the first code vector.

First radius codebook 203 receives as input the first index from code demultiplexing section 201, selects the first radius associated with the first index from the built-in codebook, and outputs the first radius to set intersection circle calculating section 207.

Second codebook 204 outputs the code vector designated by code demultiplexing section 201 to adder 205 and set intersection circle calculating section 207 as a second code vector.

Adder 205 adds the first code vector received as input from first codebook 202 and the second code vector received as input from second codebook 204, and outputs the added code vector to adjusting section 209.

Second radius codebook 206 receives as input the second index from code demultiplexing section 201, selects a second radius associated with the second index from the built-in codebook and outputs the second radius to set intersection circle calculating section 207.

Set intersection circle calculating section 207 calculates the center and radius of a set intersection circle using the first radius received as input from first radius codebook 203, the second radius received as input from second radius codebook 206 and the second code vector received as input from second codebook 204, and outputs the results to adjusting section 209.

Third codebook 208 outputs the code vector designated by code demultiplexing section 201 to adder 210 as a third code vector.

Adjusting section 209 adjusts the addition result of the first code vector and second code vector from adder 205, using the center and radius of the set intersection circle received as input from set intersection circle calculating section 207, and outputs the adjusted code vector to adder 210. In third-stage vector dequantization, the result of adjusting this addition result using the center and radius of the set intersection circle and performing vector dequantization, is the same as the result of adjusting third codebook 208 using the center and radius of that set intersection circle and performing vector dequantization.

Adder 210 adds the adjusted code vector received as input from adjusting section 209 and the third code vector received as input from third codebook 208, and outputs the added vector as a quantized vector.

The operations of the components of vector dequantization apparatus 200 will be explained.

Code demultiplexing section 201 demultiplexer encoded data and finds first index d1_min, second index d2_min and third index d3_min. Further, code demultiplexing section 201 commands first codebook 202 to output a code vector corresponding to first index d1_min, commands second codebook 204 to output a code vector corresponding to second index d2_min, and commands third codebook 208 to output a code vector corresponding to third index d3_min.

Next, code demultiplexing section 201 outputs first index d1_min to first radius codebook 203 and outputs second index d2_min to second radius codebook 206.

First codebook 202 selects code vector CODE_{—}1^{(d1}^{_{—}}^{min)}(i) (i=0, 1, . . . , R−1) from first code vectors CODE_{—}1^{(d1)}(i)(d1=0, 1, . . . , D1−1, i=0, 1, . . . , R−1) forming the built-in codebook, by designation d1_min from code demultiplexing section 201, and outputs the code vector to adder 205.

First radius codebook 203 receives first index d1_min as input, selects first radius r_{—}1^{(d1}^{_{—}}^{min)} associated with first index d1_min from first radiuses r_{—}1^{(d1)} (d1=0, 1, . . . , D1−1) forming the built-in codebook, and outputs the first radius to set intersection circle calculating section 207.

Second codebook 204 selects code vector CODE_{—}2^{(d2}^{_{—}}^{min)}(i) (i=0, 1, . . . , R−1) from second code vectors CODE_{—}2^{(d2)}(i) (d2=0, 1, . . . , D2−1, i=0, 1, . . . , R−1) forming the built-in codebook, by designation d2_min from code demultiplexing section 201, and outputs the code vector to adder 205 and set intersection circle calculating section 207.

Adder 205 adds first code vector CODE_{—}1^{(d1}^{_{—}}^{min)}(i) (i=0, 1, . . . , R−1) received as input from first codebook 202 and second code vector CODE_{—}2^{(d2}^{_{—}}^{min)}(i) (i=0, 1, . . . , R−1) received as input from second codebook 204, according to following equation 11, and outputs added vector TMP(i) (i=0, 1, . . . , R−1) to adjusting section 209.

(Equation 11)

TMP(i)=CODE_{—}1^{(d1}^{_{—}}^{min)}(i)+CODE_{—}2^{(d2}^{_{—}}^{min)}(i)=(i=0, 1, . . . , R−1) [11]

Second codebook 206 receives second index d2_min as input, selects second radius r_{—}2^{(d2}^{_{—}}^{min)} associated with second index d2_min from second radiuses r_{—}2^{(d2)} (d2=0, 1, . . . , D2−1) forming the codebook, and outputs the second radius to set intersection circle calculating section 207.

Set intersection circle calculating section 207 receives second code vector CODE_{—}2^{(d2}^{_{—}}^{min)}(i) (i=0, 1, . . . , R−1) as input, and calculates distance d between the first code vector and the second code vector according to following equation 12. Although the first code vector is not used upon calculating distance d in equation 12, this is because the origin of the second code vector corresponds to the first code vector. Therefore, the length of the second code vector itself corresponds to the distance between those code vectors.

$$\begin{matrix}( Equation 12 ) & \\ d = \sqrt{{\sum }_{i = 0}^{R - 1} {( CODE\_ {2}^{( d 2 \_ min )} ( i ) )}^{2}} & [ 12 ]\end{matrix}$$

Next, set intersection circle calculating section 207 receives first radius r_{—}1^{(d1}^{_{—}}^{min)} and second radius r_{—}2^{(d2}^{_{—}}^{min)} as input, and calculates the center and radius of the set intersection circle of the first code vector cluster circle and second code vector cluster circle, according to following equations 13 and 14.

$$\begin{matrix}( Equation 13 ) & \\ CENT ( i ) = 0 ( i = 0 , 1 , … , R - 1 ) \\ cent\_r = r\_ {2}^{( d 2 \_ min )} \\ if ( \begin{matrix}( r\_ {1}^{( d 1 \_ min )} - r\_ {2}^{( d 2 \_ min )} \geq d ) or \\ ( r\_ {1}^{( d 1 \_ min )} + r\_ {2}^{( d 2 \_ min )} \leq d )\end{matrix} ) & [ 13 ] \\ ( Equation 14 ) & \\ CENT ( i ) = \frac{\begin{matrix}r\_ {1}^{( d 1 \_ min )} - \\ r\_ {2}^{( d 2 \_ min )} - \\ d\end{matrix}}{2 d} \times CODE\_ {2}^{( d 2 \_ min )} ( i ) ( i = 0 , 1 , … , R - 1 ) \\ cent\_r = \sqrt{{( r\_ {2}^{( d 2 \_ min )} )}^{2} - {\sum }_{i = 0}^{R - 1} {( CENT ( i ) )}^{2}} \\ if ( \begin{matrix}( r\_ {1}^{( d 1 \_ min )} - r\_ {2}^{( d 2 \_ min )} < d ) and \\ ( r\_ {1}^{( d 1 \_ min )} + r\_ {2}^{( d 2 \_ min )} > d )\end{matrix} ) & [ 14 ]\end{matrix}$$

Next, set intersection circle calculating section 207 outputs set intersection circle center CENT(i) (i=0, 1, . . . , R−1) and set intersection circle radius cent_r to adjusting section 209.

Third codebook 208 selects code vector CODE_{—}3^{(d3}^{_{—}}^{min)}(i) (i=0, 1, . . . , R−1) from third code vectors CODE_{—}3^{(d3)}(i) (d3=0, 1, . . . , D3−1, i=0, 1, . . . , R−1) forming the built-in codebook, by designation d3_min from code demultiplexing section 201, and outputs the code vector to adder 210.

Adjusting section 209 adjusts added vector TMP(i) (i=0, 1, . . . , R−1) received as input from adder 205 according to following equation 15, using set intersection circle center CENT(i) (i=0, 1, . . . , R−1) and set intersection circle radius cent_r received as input from set intersection circle calculating section 207.

$$\begin{matrix}( Equation 15 ) & \\ AD\_CODE \_ 3 ( i ) = \frac{cent\_r}{CBR\_ 3} \times CODE\_ {3}^{( d 3 \_ min )} ( i ) + CENT ( i ) ( i = 0 , 1 , … , R - 1 ) & [ 15 ]\end{matrix}$$

Next, adjusting section 209 outputs adjusted vector AD_CODE_{—}3(i) (i=0, 1, . . . , R−1) to adder 210.

Adder 210 adds third code vector CODE_{—}3^{(d3}^{_{—}}^{min)}(i) (i=0, 1, . . . , R−1) from third codebook 208 and adjusted vector AD_CODE_{—}3(i) (i=0, 1, . . . , R−1) received as input from adjusting section 209, according to following equation 16, and outputs added vector Q_V(i) as a quantized vector.

(Equation 16)

Q_{—}V(i)=TMP(i)+AD_CODE_{—}3(i) (i=0, 1, . . . , R−1) [16]

The first codebook, second codebook, third codebook, first radius codebook and second radius codebook used in vector quantization apparatus 100 and vector dequantization apparatus 200 are prepared in advance by learning, and the learning method of these codebooks will be explained.

To find the first codebook provided in first codebooks 101 and 202 by learning, first, much learning data (e.g. V learning vectors) are prepared. Next, using the V learning vectors, Dl first code vectors CODE_{—}1^{(d1)}(i) (d1=0, 1, . . . , D1−1, i=0, 1, . . . , R−1) are found according to learning algorithms such as the LBG (Linde Buzo Gray) algorithm, to generate the first codebook.

After first codebook learning, a first radius codebook is generated. To be more specific, vector quantization is performed for each of the V learning vectors using the generated first codebook, and to which first code vector cluster the V learning vectors each belong is memorized. Next, for each first code vector, the learning vector at the farthest distance from the first code vector is found from learning vectors belonging to the cluster of the first code vector, and this distance is used as the radius of the cluster circle of the first code vector. In this case, it is possible to extend the determined radius by multiplying this radius by a certain coefficient such that the cluster circle completely includes the cluster of the first code vector. The radius of the cluster circle associated with each first code vector is determined, and the first radius codebook is formed with these radiuses.

To find the second codebook provided in second codebooks 105 and 204, first, using the V learning vectors, first-stage vector quantization is performed with the first codebook found in the above method to find V first residual vectors Err_{—}1^{(d1}^{_{—}}^{min)}(i) (i=0, 1, . . . , R−1) to be outputted by adder 102. Next, using V first residual vectors Err_{—}1^{(d1}^{_{—}}^{min)}(i) (i=0, 1, . . . , R−1), D2 second code vectors CODE_{—}2^{(d2)}(i) (d2=0, 1, . . . , D1−1, i=0, 1, . . . , R−1) are found according to learning algorithms such as the LBG algorithm to generate the second codebook.

Also, after second codebook learning, a second radius codebook is generated. To be more specific, vector quantization is performed for each of the V first residual vectors using the generated second codebook, and to which second code vector cluster the V first residual vectors each belong is memorized. Next, for each second code vector, the learning vector to provide the farthest distance between the second code vector and the first residual vector is found from first residual vectors belonging to the cluster of the second code vector, and this distance is used as the radius of the cluster circle of the second code vector. In this case, it is possible to extend the determined radius by multiplying this radius by a certain coefficient such that the cluster circle completely includes the cluster of the second code vector. The radius of the cluster circle associated with each second code vector is determined, and the second radius codebook is formed with these radiuses.

To find the third codebook provided in third codebooks 110 and 208, first, using the V first residual vectors, first-stage vector quantization and second-stage vector quantization are performed with the first codebook and second codebook found in the above method to find V second residual vectors Err_{—}2^{(d2}^{_{—}}^{min)}(i) (i=0, 1, . . . , R−1) to be outputted by adder 106. Next, using V second residual vectors Err_{—}2^{(d2}^{_{—}}^{min)}(i) (i=0, 1, . . . , R−1), D3 third code vectors CODE_{—}3^{(d3)}(i) (d3=0, 1, . . . , D1−1, i=0, 1, . . . , R−1) are found according to learning algorithms such as the LBG algorithm to generate the third codebook.

The above learning methods are just examples, and it is equally possible to provide the effect of the present invention by generating codebooks with other methods than the above methods.

Thus, according to the present embodiment, by approximating the cluster of each code vector by a circle, storing the radius of each cluster circle in the form of a radius codebook and matching a third codebook in third-stage vector quantization to a set intersection circle of the first code vector cluster circle and second code vector cluster circle, it is possible to improve the accuracy of quantization in third-stage vector quantization.

Also, although an example case has been described above with the present embodiment where the center and radius of a set intersection circle is used to adjust a second residual vector, the present invention is not limited to this, and it is equally possible to provide the same quantization effect by adjusting a third codebook using the center and radius of a set intersection circle.

Also, although an example case has been described above with the present embodiment where vector quantization is performed in three stages, the present invention is not limited to this, and it is equally possible to perform vector quantization in two stages or vector quantization in four or more stages.

For example, in a case where the present invention is applied to vector quantization in two stages, by setting the center of the set intersection of cluster circles, CENT(i) (i=0, 1, . . . , R−1), as a zero vector and setting set intersection circle radius cent_r as first radius r_{—}1^{(d1}^{_{—}}^{min)}, the cluster circle of the first code vector is used as is as the set intersection circle, and the first residual vector is adjusted according to following equation 17.

$$\begin{matrix}( Equation 17 ) & \\ AD\_Err \_ 1 ( i ) = \frac{CBR\_ 2}{cent\_r} \times ( \begin{matrix}Err\_ {1}^{( d 1 \_ min )} ( i ) - \\ CENT ( i )\end{matrix} ) ( i = 0 , 1 , … , R - 1 ) & [ 17 ]\end{matrix}$$

In equation 17, CBR_{—}2 is the value showing the expanse of second codebook 105, and equals the distance between the zero point and the second code vector farthest from the zero point among second code vectors of second codebook 105. This value is determined at the time second codebook 105 is prepared in advance by learning algorithms.

For example, in a case where the present invention is applied to vector quantization in four or more stages, upon generating codebooks used in the third or subsequent stages, the radius codebooks in third or subsequent stages are generated in advance. Further, after performing vector quantization in three stages described in the present embodiment, for example, in fourth-stage vector quantization, set intersection circle calculating section 108 receives as input third radius r_{—}3^{(d3}^{_{—}}^{min)} and set intersection circle radius cent_r in up to earlier stages, and newly finds a set intersection circle of the third code vector cluster circle and the set intersection circle in up to the earlier stages, according to following equations 18 to 20.

$$\begin{matrix}( Equation 18 ) & \\ d = \sqrt{{\sum }_{i = 0}^{R - 1} {( CODE\_ {3}^{( d 3 \_ min )} ( i ) )}^{2}} \\ ( Equation 19 ) & [ 18 ] \\ {cent\_r}^{′} = cent\_r \\ if ( ( cent\_r - r\_ {3}^{( d 3 \_ min )} \geq d ) or ( cent\_r + r\_ {3}^{( d 3 \_ min )} \leq d ) ) \\ ( Equation 20 ) & [ 19 ] \\ CENT ( i ) = \frac{cent\_r - r\_ {3}^{( d 3 \_ min )} - d}{2 d} \times CODE\_ {3}^{( d 3 \_ min )} ( i ) ( i = 0 , 1 , … , R - 1 ) \\ cent\_r = \sqrt{{( r\_ {3}^{( d 3 \_ min )} )}^{2} - {\sum }_{i = 0}^{R - 1} {( CENT ( i ) )}^{2}} \\ if ( ( cent\_r - r\_ {3}^{( d 3 \_ min )} < d ) and ( cent\_r + r\_ {3}^{( d 3 \_ min )} > d ) ) & [ 20 ]\end{matrix}$$

Thus, in a case where the present invention is applied to vector quantization in four or more stages, set intersection circles are sequentially found according to an increased number of stages.

Also, an example case has been described above with the present embodiment where, using the radius of the cluster circle of the first code vector and the radius of the cluster circle of a second code vector, a third codebook is adapted to a set intersection circle of the first code vector cluster circle and second code vector cluster circle. However, the present invention is not limited to this, and, with other methods, it is equally possible to adapt the third codebook to the set intersection circle of the cluster circle of the first codebook and the cluster circle of the second codebook.

Also, by adopting a method of approximating the cluster of each code vector by a circle, although the first code vector is not used upon calculating distance d between the first code vector and a second code vector, if other approximation methods are applied, it is equally possible to use the first code vector if necessary.

Also, although vector dequantization apparatus 200 decodes quantized vector codes transmitted from vector quantization apparatus 100 in the present embodiment, the present invention is not limited to this, and it naturally follows that vector dequantization apparatus 200 can receive and decode encoded data even if this encoded data is not transmitted from vector quantization apparatus 100, as long as that encoded data as quantized vector codes is in a form that can be decoded in vector dequantization apparatus 200.

### Embodiment 2

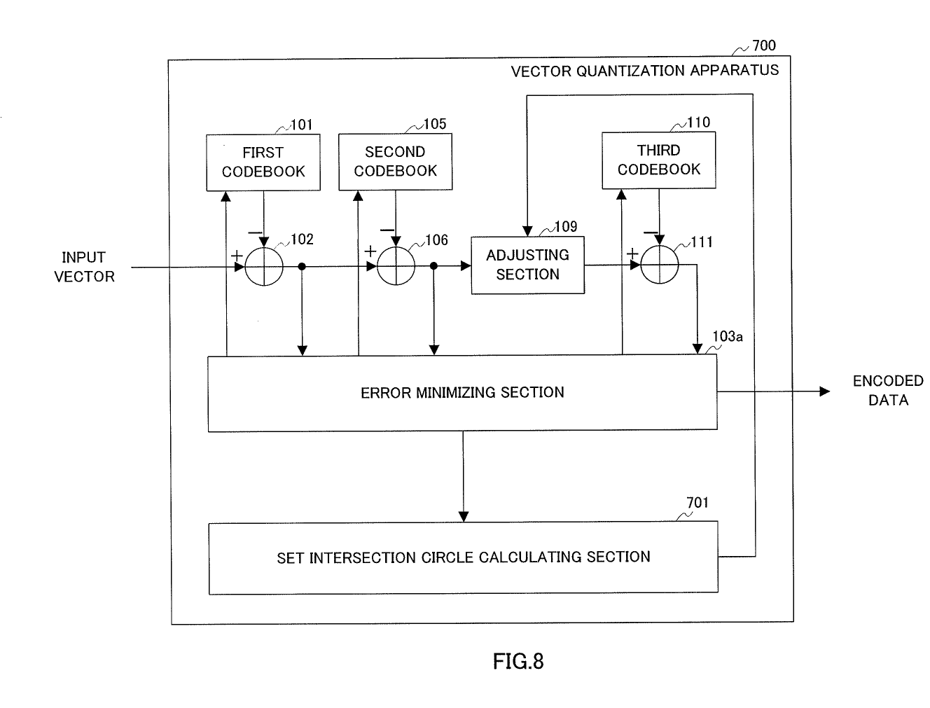

FIG. 8 is a block diagram showing the configuration of vector quantization apparatus 700 according to Embodiment 2 of the present invention. Also, vector quantization apparatus 700 has the same basic configuration as vector quantization apparatus 100 (see FIG. 5) shown in Embodiment 1, and therefore the same components will be assigned the same reference numerals and their explanation will be omitted.

Error minimizing section 103a calculates the square errors between an input vector and first code vectors using a first residual vector received as input from adder 102, and selects the first code vector to minimize the square error from first codebook 101. Next, error minimizing section 103a calculates the square errors between the first residual vector and second code vectors using a second residual vector received as input from adder 106, and selects the second code vector to minimize the square error from second codebook 105. Further, error minimizing section 103a calculates the square errors between the second residual vector and third code vectors, using a third residual vector received as input from adder 111, and selects the third code vector to minimize the square error from third codebook 110. Processing of selecting these code vectors is sequentially performed so that a code vector is selected from one codebook before a code vector is selected from the next codebook. Further, error minimizing section 103a outputs the index of the first code vector and the index of the second code vector to set intersection circle calculating section 701 every time these code vectors are selected. Next, error minimizing section 103a collectively encodes the indices assigned to the three selected code vectors and outputs the resulting encoded data.

Set intersection circle calculating section 701 has a set intersection circle codebook, which will be described later. Further, set intersection circle calculating section 701 receives as input a first code vector index (i.e. first index) and second code vector index (i.e. second index) from error minimizing section 103a, selects the center and radius of the set intersection circle based on the set intersection circle codebook and input indices, and outputs the results to adjusting section 109.

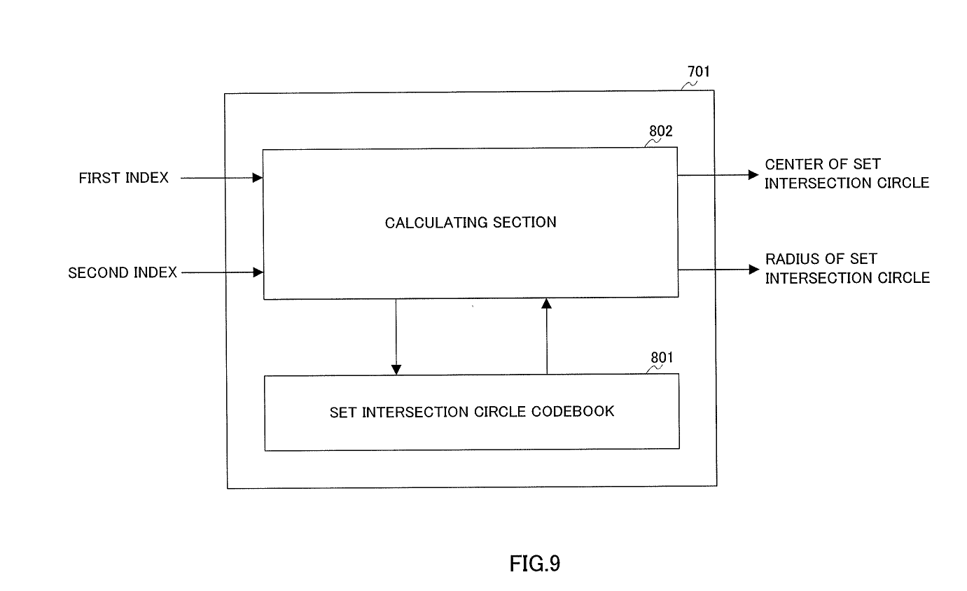

FIG. 9 is a block diagram showing the configuration of set intersection circle calculating section 701 according to Embodiment 2 of the present invention. Here, set intersection circle calculating section 701 is provided with set intersection circle codebook 801 and calculating section 802.

Set intersection circle codebook 801 associates set intersection circle center CENT^{(idx)}(i) (i=0, 1, . . . , R−1) and set intersection circle radius cent_r^{(idx)}, and has the results inside in the form of codebook. Here, idx is the representative value associated with the combination of two indices of first index d1_min and second index d2_min. For example, if d1_min can have D1 kinds of values from 0 to D1−1 and d2_min can have D2 kinds of values from 0 to D2−1, idx can be expressed as shown in equation.21. That is, set intersection circle codebook 801 is a set intersection circle codebook whereby set intersection circle center CENT^{(idx)}(i) and set intersection circle radius cent_r^{(idx)} can be determined uniquely from first index d1_min and second index d2_min.

$$\begin{matrix}( Equation 21 ) & \\ idx = d 1 \_min + D 1 \times d 2 \_min \\ or \\ idx = D 2 \times d 1 \_min + d 2 \_min & [ 21 ]\end{matrix}$$

Calculating section 802 receives as input first index d1_min and second index d2_min from error minimizing section 103a, and calculates idx using equation 21.

Next, calculating section 802 extracts set intersection circle center CENT^{(idx)}(i) (i=0, 1, . . . , R−1) and set intersection circle radius cent_r^{(idx)} associated with idx, from the codebook of set intersection circle codebook 801, and outputs these to adjusting section 109.

With respect to idx for all combinations of first index d1_min and second index d2_min, by calculating set intersection circle center CENT^{(idx)}(i) (i=0, 1, . . . , R−1) and set intersection circle radius cent_r^{(idx)} using equations 6 and 7, it is possible to prepare in advance the codebook provided in set intersection circle codebook 801.

Thus, the present embodiment provides a feature of performing calculations in a set intersection circle calculating section (in equations 6 and 7) in advance and storing the calculation results in the form of a codebook. With this configuration, in addition to the effect of above Embodiment 1, the present embodiment needs not perform calculations (in equations 6 and 7) upon coding, so that it is possible to reduce the amount of calculations. That is, although the radius and center of a set intersection circle are determined by calculations using the first radius, second radius, first code vector and second code vector in above Embodiment 1, like the present embodiment, it is equally possible to provide the effect of the present invention by determining in advance the radiuses and centers in all combinations by calculations and providing the determined radiuses and centers in the form of a codebook. In this case, the radiuses and centers are calculated in advance, so that it is not necessary to calculate the radiuses and centers again upon quantization, thereby reducing the amount of calculations compared to Embodiment 1.

### Embodiment 3

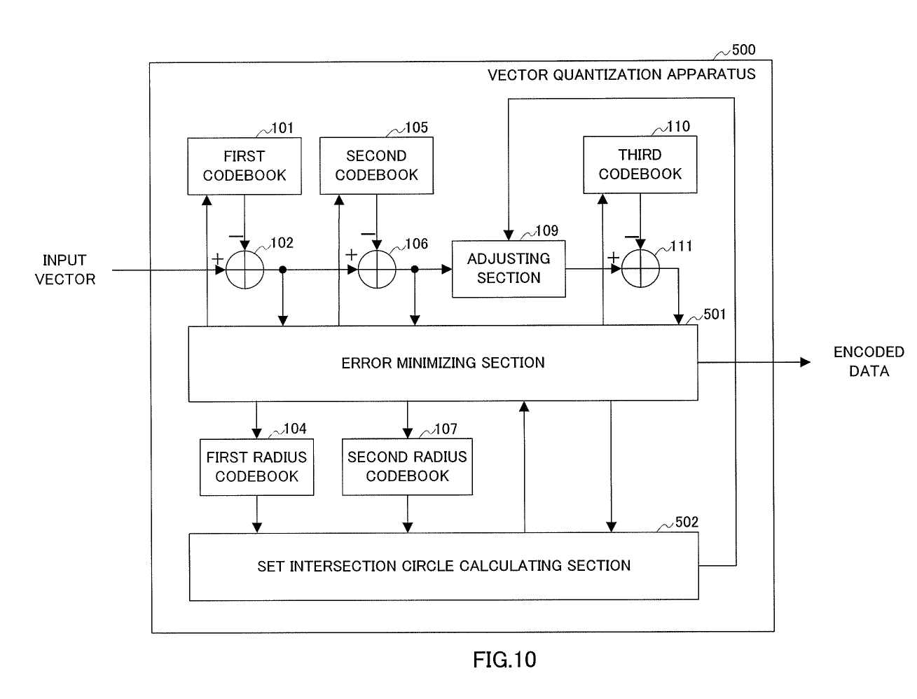

FIG. 10 is a block diagram showing the main components of vector quantization apparatus 500 according to Embodiment 3 of the present invention. Here, vector quantization apparatus 500 has the same basic configuration as vector quantization apparatus 100 (see FIG. 5) shown in Embodiment 1, and therefore the same components will be assigned the same reference numerals and their explanation will be omitted.

Vector quantization apparatus 500 is provided with first codebook 101, adder 102, error minimizing section 501, first radius codebook 104, second codebook 105, adder 106, second radius codebook 107, set intersection circle calculating section 502, adjusting section 109, third codebook 110 and adder 111.

Error minimizing section 501 calculates the square errors between an input vector and first code vectors using a first residual vector received as input from adder 102, and selects the first code vector to minimize the square error from first codebook 101. Further, error minimizing section 501 outputs the index of the selected first code vector to first radius codebook 104.

Next, error minimizing section 501 calculates the square errors between the first residual vector and second code vectors using a second residual vector received as input from adder 106, and, as selection candidates, selects a plurality of second code vectors in order from the lowest square error, from second codebook 105. In other words, as selection candidates, error minimizing section 501 extracts a plurality of second code vectors in order from the second code vector closest to the first residual vector, from second codebook 105. Further, error minimizing section 501 outputs the indices of the plurality of second code vectors selected as selection candidates, to second radius codebook 107, and outputs the plurality of second code vectors selected as selection candidates to set intersection circle calculating section 502. Further, error minimizing section 501 selects the second code vector to minimize the set intersection circle radius, among the set intersection circle radiuses for the plurality of second code vectors which are received as input from set intersection circle calculating section 502 and which are selected as selection candidates. Further, error minimizing section 501 outputs the index of the second code vector to minimize the set intersection circle radius, to second radius codebook 107 again.

Next, error minimizing section 501 calculates the square errors between the second residual vector and third code vectors using a third residual vector received as input from adder 111, and selects the third code vector to minimize the square error from third codebook 110. Processing of selecting these code vectors is sequentially performed so that a code vector is selected from one codebook before a code vector is selected from the next codebook. Further, error minimizing section 501 collectively encodes the indices assigned to the three selected code vectors and outputs the resulting encoded data.

Using the first radius received as input from first radius codebook 104, second radiuses which are received as input from second radius codebook 107 and which are respectively associated with a plurality of second code vectors selected as selection candidates in error minimizing section 501, and the plurality of second code vectors received as input from error minimizing section 501, set intersection circle calculating section 502 calculates the set intersection circle radiuses for the plurality of second code vectors selected as selection candidates in error minimizing section 501, and outputs the radiuses of all set intersection circles to error minimizing section 501. Next, as in Embodiment 1, using the first radius, second radius received as input again from second radius codebook 107 and second code vector, set intersection circle calculating section 502 calculates a vector and coefficient (i.e. the center and radius of the set intersection circle) to use for adjustment in third codebook 110 (actually, adjustment in the second residual vector), and outputs the results to adjusting section 109.

The operations of the components of vector quantization apparatus 500 will be explained. Here, an example case will be explained where the order of an input vector of the quantization target is R.

Error minimizing section 501 designates code vector index d2′ to second codebook 105 and calculates square error Err according to following equation 22, using second residual vector Err_{—}2^{(d2′)}(i) (i=0, 1, . . . , R−1) received as input from adder 106 every designation.

$$\begin{matrix}( Equation 22 ) & \\ Err = {\sum }_{i = 0}^{R - 1} {( Err\_ {2}^{( d {2}^{′} )} ( i ) )}^{2} & [ 22 ]\end{matrix}$$

Here, error minimizing section 501 calculates square error Err with respect to all second code vectors, and selects X second code vectors in order from the lowest value of square error Err, as selection candidates. Further, error minimizing section 501 outputs the indices of X selected second code vectors, d2_min(x) (x=0, 1, . . . , X−1), to second radius codebook 107. Further, error minimizing section 501 outputs X selected code vectors CODE_{—}2^{(d2}^{_{—}}^{min(x))} (i) (i=0, 1, . . . , R−1) to set intersection circle calculating section 502. Here, as for the value of X, a preliminary experiment based on a large amount of input data may be performed in advance to set the value providing the best performance as X.

Second radius codebook 107 outputs X second radiuses r_{—}2^{(d2}^{_{—}}^{min(x))} respectively associated with X second indices d2_min(x) (x=0, 1, . . . , X−1) received as input from error minimizing section 501, among second radiuses r_{—}2^{(d2)} (d2=0, 1, . . . , D2−1) forming the built-in codebook, to set intersection circle calculating section 502.

Using X second code vectors CODE_{—}2^{(d2}^{_{—}}^{min(x))}(i) (i=0, 1, . . . , R−1) received as input from error minimizing section 501, set intersection circle calculating section 502 calculates distance d(x) between the first code vector and second code vectors, according to following equation 23. As in Embodiment 1, although the first code vector is not used upon calculating distance d(x) in equation 23, this is because the origin of each second code vector corresponds to the first code vector. Therefore, the length of each second code vector itself corresponds to the distance between the first code vector and the second code vector.

$$\begin{matrix}( Equation 23 ) & \\ d ( x ) = \sqrt{{\sum }_{i = 0}^{R - 1} {( CODE\_ {2}^{( d 2 \_ min ( x ) )} ( i ) )}^{2}} & [ 23 ]\end{matrix}$$

Next, according to following equations 24 and 25, set intersection circle calculating section 502 finds approximate radiuses of the set intersections of the first code vector cluster circle and second code vector cluster circles, using calculated distance d(x), first radius r_{—}1^{(d1}^{_{—}}^{min)} received as input from first radius codebook 104, second radiuses r_{—}2^{(d2}^{_{—}}^{min(x))} received as input from second radius codebook 107 and second code vectors CODE_{—}2^{(d2}^{_{—}}^{min(x))}(i) (i=0, 1, . . . , R−1) received as input from error minimizing section 501.

$$\begin{matrix}( Equation 24 ) & \\ cent\_r ( x ) = r\_ {2}^{( d 2 \_ min ( x ) )} \\ if ( \begin{matrix}( r\_ {1}^{( d 1 \_ min )} - r\_ {2}^{( d 2 \_ min ( x ) )} \geq d ( x ) ) or \\ ( r\_ {1}^{( d 1 \_ min )} + r\_ {2}^{( d 2 \_ min ( x ) )} \leq d ( x ) )\end{matrix} ) \\ ( Equation 25 ) & [ 24 ] \\ CENT ( i ) = \frac{r\_ {1}^{( d 1 \_ min )} - r\_ {2}^{( d 2 \_ min ( x ) )} - d ( x )}{2 d ( x )} \times CODE\_ {2}^{( d 2 \_ min ( x ) )} ( i ) ( i = 0 , 1 , … , R - 1 ) \\ cent\_r ( x ) = \sqrt{{( r\_ {2}^{( d 2 \_ min ( x ) )} )}^{2} - {\sum }_{i = 0}^{R - 1} {( CENT ( i ) )}^{2}} \\ if ( \begin{matrix}( r\_ {1}^{( d 1 \_ min )} - r\_ {2}^{( d 2 \_ min ( x ) )} < d ( x ) ) and \\ ( r\_ {1}^{( d 1 \_ min )} + r\_ {2}^{( d 2 \_ min ( x ) )} > d ( x ) )\end{matrix} ) & [ 25 ]\end{matrix}$$

Further, set intersection circle calculating section 502 outputs X calculated set intersection circle radiuses cent_r(x) to error minimizing section 501.

Error minimizing section 501 stores index d2_min(x_min) of the second code vector to provide minimum radius cent_r(x_min) among X set intersection circle radiuses cent_r(x) received as input from set intersection circle calculating section 502, as second index d2_min, and outputs second index d2_min to second radius codebook 107. Further, error minimizing section 501 outputs second code vector CODE_{—}2^{(d2}^{_{—}}^{min)}(i) (i=0, 1, . . . , R−1) to minimize the set intersection circle radius, to set intersection circle calculating section 502.

Second radius codebook 107 outputs second radius r_{—}2^{(d2}^{_{—}}^{min)} associated with second index d2_min received as input from error minimizing section 501, to set intersection circle calculating section 502, among second radiuses r_{—}2^{(d2)} (d2=0, 1, . . . , D2−1) forming the built-in codebook.

Using second code vector CODE_{—}2^{(d2}^{_{—}}^{min)}(i) (i=0, 1, . . . , R−1) received as input from error minimizing section 501, set intersection circle calculating section 502 calculates distance d between the first code vector and the second code vector according to following equation 26.

$$\begin{matrix}( Equation 26 ) & \\ d = \sqrt{{\sum }_{i = 0}^{R - 1} {( CODE\_ {2}^{( d 2 \_ min )} ( i ) )}^{2}} & [ 26 ]\end{matrix}$$

Next, according to following equations 27 and 28, set intersection circle calculating section 502 finds an approximate center and radius of the set intersection circle of the first code vector cluster circle and second code vector cluster circle, using calculated distance d, first radius r_{—}1^{(d1}^{_{—}}^{min)} received as input from first radius codebook 104, second radius r_{—}2^{(d2}^{min)} received as input from second radius codebook 107 and second code vector CODE_{—}2^{(d2}^{_{—}}^{min)}(i) (i=0, 1, . . . , R−1) received as input from error minimizing section 501.

$$\begin{matrix}( Equation 27 ) & \\ CENT ( i ) = 0 ( i = 0 , 1 , … , R - 1 ) \\ cent\_r = r\_ {2}^{( d 2 \_ min )} \\ if ( \begin{matrix}( r\_ {1}^{( d 1 \_ min )} - r\_ {2}^{( d 2 \_ min )} \geq d ) or \\ ( r\_ {1}^{( d 1 \_ min )} + r\_ {2}^{( d 2 \_ min )} \leq d )\end{matrix} ) \\ ( Equation 28 ) & [ 27 ] \\ CENT ( i ) = \frac{\begin{matrix}r\_ {1}^{( d 1 \_ min )} - \\ r\_ {2}^{( d 2 \_ min )} - \\ d\end{matrix}}{2 d} \times CODE\_ {2}^{( d 2 \_ min )} ( i ) ( i = 0 , 1 , … , R - 1 ) \\ cent\_r = \sqrt{{( r\_ {2}^{( d 2 \_ min )} )}^{2} - {\sum }_{i = 0}^{R - 1} {( CENT ( i ) )}^{2}} \\ if ( \begin{matrix}( r\_ {1}^{( d 1 \_ min )} - r\_ {2}^{( d 2 \_ min )} < d ) and \\ ( r\_ {1}^{( d 1 \_ min )} + r\_ {2}^{( d 2 \_ min )} > d )\end{matrix} ) & [ 28 ]\end{matrix}$$

Further, set intersection circle calculating section 502 outputs set intersection circle center CENT(i) (i=0, 1, . . . , R−1) and set intersection circle radius cent_r to adjusting section 109.

Thus, as an evaluation measure for selection of a second code vector in second-stage vector quantization, vector quantization apparatus 500 uses the radius size of the set intersection circle of the first code vector cluster circle and second code vector cluster circle, in addition to the distance between the second code vector and the quantization target vector. Here, in third-stage vector quantization, a third-stage codebook (in FIG. 10, third codebook 110) is made to match the set intersection circle of the first code vector cluster circle and second code vector cluster circle. That is, when the set intersection circle radius is smaller, the search range of third code vectors in third-stage vector quantization becomes smaller. Therefore, by selecting the second code vector to minimize the set intersection circle radius after second-stage vector quantization, vector quantization apparatus 500 can perform a search only in the minimum search range upon third-stage vector quantization, and select a third code vector. Therefore, according to the present embodiment, it is possible to improve the accuracy of quantization in third-stage vector quantization like Embodiment 1, and further improve the efficiency of quantization in third-stage vector quantization.

Also, in the present embodiment, set intersection circle center CENT(i) (i=0, 1, . . . , R−1) and set intersection circle radius cent_r calculated in equations 24 and 25 or equations 27 and 28 are uniquely determined by the combination of two indices received as input in set intersection circle calculating section 502. Therefore, with the present invention, if there is enough memory, as in Embodiment 2, it is possible to calculate in advance set intersection circle center CENT(i) (i=0, 1, . . . , R−1) and set intersection circle radius cent_r in all index combinations and store the calculated set intersection circle centers and set intersection circle radiuses in the memory in the form of a set intersection circle codebook. By this means, in vector quantization apparatus 500, it is possible to omit calculations for calculating the centers and radiuses of set intersection circles in vector quantization.

Also, an example case has been described above with the present embodiment where a second code vector is determined in the steps of, in vector quantization apparatus 500, selecting a plurality of second code vectors in order from lowest square error Err, as selection candidates, and selecting one second code vector to minimize the set intersection circle radius from the selection candidates. However, in the present invention, the method of determining a second code vector taking into account the set intersection circle radius is not limited to the above. For example, vector quantization apparatus 500 may calculate square error Err^{(d2)} (d2=0, 1, . . . , D2−1) with respect to all second code vectors according to equation 22, calculate set intersection circle centers cent_r^{(d2)} (d2=0, 1, . . . , D2−1) with respect to all second code vectors, and select the second code vector to minimize evaluation measure Y calculated in following equation 29. That is, vector quantization apparatus 500 may select a second code vector, according to an evaluation measure using the distance between second code vectors and an input vector (i.e. quantization target vector) and using the radiuses of the set intersection circles of the first code vector cluster circle and second code vector cluster circles.

(Equation 29)

Y=Err^{(d2′)}+α×cent_{—}r^{(d2′)} [29]

Here, α is the weight to determine to which extent the set intersection circle radius is taken into account as an evaluation measure, and may be set as the value providing the best performance in a preliminary experiment conducted in advance with a large amount of input data.

Embodiments of the present invention have been described above.

Also, it is possible to employ the configuration of Embodiment 2 when there is enough memory or employ the configuration of Embodiment 1 when there is enough time for calculation, so that it is possible to select a configuration depending on necessary conditions.

Also, although example cases of performing multi-stage vector quantization have been described with the above embodiments, the present invention is not limited to this, and it is equally possible to perform vector quantization together with split vector quantization.

Also, the vector quantization apparatus, vector dequantization apparatus, and vector quantization and dequantization methods according to the present embodiment are not limited to the above embodiments, and can be implemented with various changes.

For example, although the vector quantization apparatus, vector dequantization apparatus, and vector quantization and dequantization methods of the above embodiments have been described to target speech signals, these apparatuses and methods are equally applicable to audio signals and so on.

Also, the vector quantization apparatus and vector dequantization apparatus according to the present embodiment can provide high performance in vector quantization of linear predictive coefficients in speech or audio coding.

The vector quantization apparatus and vector dequantization apparatus according to the present invention can be mounted on a communication terminal apparatus in a mobile communication system that transmits speech, so that it is possible to provide a communication terminal apparatus having the same operational effect as above.

Although example cases have been described with the above embodiments where the present invention is implemented with hardware, the present invention can be implemented with software. For example, by describing the vector quantization method and vector dequantization method according to the present invention in a programming language, storing this program in a memory and making the information processing section execute this program, it is possible to implement the same function as in the vector quantization apparatus and vector dequantization apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2008-007417, filed on Jan. 16, 2008, Japanese Patent Application No. 2008-143278, filed on May 30, 2008, and Japanese Patent Application No. 2008-317398, filed on Dec. 12, 2008, including the specifications, drawings and abstracts, are included herein by reference in their entireties.

### INDUSTRIAL APPLICABILITY

The vector quantization apparatus, vector dequantization apparatus, and vector quantization and dequantization methods according to the present invention are applicable to such uses as speech coding and speech decoding.

1. A vector quantization apparatus comprising:
N codebooks from a first codebook to an N-th codebook (where N is an integer equal to or greater than 3) that each store a plurality of code vectors;
(N−1) radius codebooks from a first radius codebook to an (N−1)-th radius codebook that store radiuses of cluster circles showing vector sets represented respectively by code vectors of the first codebook to the (N−1)-th codebook;
a first calculating section that calculates a difference between each code vector of the first codebook and a quantization target vector, as a first residual vector;
an m-th calculating section that calculates a difference between each code vector of an m-th (m=2, 3, . . . , N−1) codebook and an (m−1)-th residual vector associated with a code vector selected from an (m−1)-th codebook, as an m-th residual vector;
a set intersection circle calculating section that calculates a set intersection circle showing a set intersection of a cluster circle of a code vector selected from an (N−2)-th codebook and a cluster circle of a code vector selected from the (N−1)-th codebook;
an adjusting section that adjusts one of an (N−1)-th residual vector associated with the code vector selected from the (N−1)-th codebook and the N-th codebook, such that a cluster circle of the N-th codebook showing all vector sets represented by all vectors of the N-th codebook and the set intersection circle match each other;
an N-th calculating section that calculates a difference between the (N−1)-th residual vector associated with the code vector selected from the (N−1)-th codebook and each code vector of the N-th codebook adjusted, or calculates a difference between the (N−1)-th residual vector adjusted and each code vector of the N-th codebook, as an N-th residual vector; and
a selecting section that selects a code vector closest to the quantization target vector from the first codebook and selects a code vector closest to an (n−1)-th residual vector from an n-th (where n=2, 3, . . . , N) codebook.

2. The vector quantization apparatus according to claim 1, wherein the set intersection circle calculating section calculates a radius and center of the set intersection circle, using a radius of the cluster circle of the code vector selected from the (N−2)-th codebook and a radius of the cluster circle of the code vector selected from the (N−1)-th codebook.

3. The vector quantization apparatus according to claim 1, wherein the adjusting section moves a center and changes a radius, with respect to the cluster circle of the N-th codebook.

4. The vector quantization apparatus according to claim 1, wherein the adjusting section moves and changes a size of the (N−1)-th residual vector associated with the code vector selected from the (N−1)-th codebook.

5. A vector quantization apparatus comprising:
N codebooks from a first codebook to an N-th codebook (where N is an integer equal to or greater than 3) that each store a plurality of code vectors;
a first calculating section that calculates a difference between each code vector of the first codebook and a quantization target vector, as a first residual vector;
an m-th calculating section that calculates a difference between each code vector of an m-th (m=2, 3, . . . , N−1) codebook and an (m−1)-th residual vector associated with a code vector selected from an (m−1)-th codebook, as an m-th residual vector;
a quantization section that acquires an (m−1)-th code by performing vector quantization of one of an input vector and the (m−1)-th residual vector using the (m−1)-th codebook, and acquires an m-th code by performing vector quantization of the m-th residual vector;
a set intersection circle calculating section that selects and outputs a radius and center of a set intersection circle showing a set intersection of a cluster circle of a code vector selected from an (N−2)-th codebook and a cluster circle of a code vector selected from an (N−1)-th codebook, based on an (N−2)-th code and (N−1)-th code;
an adjusting section that adjusts one of an (N−1)-th residual vector associated with the code vector selected from the (N−1)-th codebook and the N-th codebook, such that a cluster circle of the N-th codebook showing all vector sets represented by all vectors of the N-th codebook and the set intersection circle match each other;
an N-th calculating section that calculates a difference between the (N−1)-th residual vector associated with the code vector selected from the (N−1)-th codebook and each code vector of the N-th codebook adjusted, or calculates a difference between the (N−1)-th residual vector adjusted and each code vector of the N-th codebook, as an N-th residual vector; and
a selecting section that selects a code vector closest to the quantization target vector from the first codebook and selects a code vector closest to an (n−1)-th residual vector from an n-th (where n=2, 3, . . . , N) codebook.

6. The vector quantization apparatus according to claim 5, wherein the set intersection circle calculating section has a set intersection circle codebook that enables the radius and the center to be uniquely determined by a first code and the m-th code.

7. A vector quantization apparatus comprising:
N codebooks from a first codebook to an N-th codebook (where N is an integer equal to or greater than 3) that each store a plurality of code vectors;
(N−1) radius codebooks from a first radius codebook to an (N−1)-th radius codebook that store radiuses of cluster circles showing vector sets represented respectively by code vectors of the first codebook to the (N−1)-th codebook;
a first calculating section that calculates a difference between each code vector of the first codebook and a quantization target vector, as a first residual vector;
an m-th calculating section that calculates a difference between each code vector of an m-th (m=2, 3, . . . , N−1) codebook and an (m−1)-th residual vector associated with a code vector selected from an (m−1)-th codebook, as an m-th residual vector;
a set intersection circle calculating section that calculates a set intersection circle showing a set intersection of a cluster circle of a code vector selected from an (N−2)-th codebook and a cluster circle of a code vector selected from the (N−1)-th codebook;
an adjusting section that adjusts one of an (N−1)-th residual vector associated with the code vector selected from the (N−1)-th codebook and the N-th codebook, such that a cluster circle of the N-th codebook showing all vector sets represented by all vectors of the N-th codebook and the set intersection circle match each other;
an N-th calculating section that calculates a difference between the (N−1)-th residual vector associated with the code vector selected from the (N−1)-th codebook and each code vector of the N-th codebook adjusted, or calculates a difference between the (N−1)-th residual vector adjusted and each code vector of the N-th codebook, as an N-th residual vector; and
a selecting section that selects a code vector closest to the quantization target vector from the first codebook, selects a code vector closest to an (n−1)-th residual vector from an n-th (where n=2, 3, . . . , N) codebook, and, among a plurality of code vectors extracted from the (N−1)-th codebook in order from a code vector closest to an (N−2)-th residual vector, selects a code vector to minimize a radius of the set intersection circle showing the set intersection with the cluster circle of the code vector selected from the (N−2)-th codebook.

8. A vector dequantization apparatus comprising:
a receiving section that receives an n-th code (n=1, 2, . . . , N, where N is an integer equal to or greater than 3) acquired by performing quantization in an n-th stage for an input vector in a vector quantization apparatus;
N codebooks from a first codebook to an N-th codebook that each store a plurality of code vectors;
(N−1) radius codebooks from a first radius codebook to an (N−1)-th radius codebook that store radiuses of cluster circles showing vector sets represented respectively by code vectors of the first codebook to the (N−1)-th codebook;
a first adding section that acquires a first addition vector by adding a code vector indicated by a first code in the first codebook and a code vector indicated by a second code in a second codebook;
an m-th adding section that acquires an m-th addition vector by adding a code vector indicated by an m-th (m=2, 3, . . . , N−1) code in an m-th codebook and an (m−1)-th addition vector;
a set intersection circle calculating section that calculates a set intersection circle showing a set intersection of a cluster circle of a code vector indicated by an (N−2)-th code in an (N−2)-th codebook and a cluster circle of a code vector indicated by an (N−1)-th code in the (N−1)-th codebook;
an adjusting section that adjusts one of an (N−1)-th addition vector and an N-th code vector, such that a cluster circle of the N-th code vector, which is a code vector indicated by an N-th code in the N-th codebook, and the set intersection circle match each other; and
an N-th adding section that acquires a quantized vector by adding the N-th code vector adjusted and the (N−1)-th addition vector or by adding the (N−1)-th addition vector adjusted and the N-th code vector.

9. A vector quantization method comprising:
N codebooks from a first codebook to an N-th codebook (where N is an integer equal to or greater than 3) that each store a plurality of code vectors;
(N−1) radius codebooks from a first radius codebook to an (N−1)-th radius codebook that store radiuses of cluster circles showing vector sets represented respectively by code vectors of the first codebook to the (N−1)-th codebook;
a first calculating step of calculating a difference between each code vector of the first codebook and a quantization target vector, as a first residual vector;
an m-th calculating step of calculating a difference between each code vector of an m-th (m=2, 3, . . . , N−1) codebook and an (m−1)-th residual vector associated with a code vector selected from an (m−1)-th codebook, as an m-th residual vector;
a set intersection circle calculating step of calculating a set intersection circle showing a set intersection of a cluster circle of a code vector selected from an (N−2)-th codebook and a cluster circle of a code vector selected from the (N−1)-th codebook;
an adjusting step of adjusting one of an (N−1)-th residual vector associated with the code vector selected from the (N−1)-th codebook and the N-th codebook, such that a cluster circle of the N-th codebook showing all vector sets represented by all vectors of the N-th codebook and the set intersection circle match each other;
an N-th calculating step of calculating a difference between the (N−1)-th residual vector associated with the code vector selected from the (N−1)-th codebook and each code vector of the N-th codebook adjusted, or calculating a difference between the (N−1)-th residual vector adjusted and each code vector of the N-th codebook, as an N-th residual vector; and
a selecting step of selecting a code vector closest to the quantization target vector from the first codebook and selecting a code vector closest to an (n−1)-th residual vector from an n-th (where n=2, 3, . . . , N) codebook.
